(19) United States
(12) Patent Application Publication
(10) Pub. No.: US 2007/0067451 A1
(43) Pub. Date: Mar. 22, 2007

(54) Communication system, interaction history browsing method, history management device and communication terminal

(75) Inventor: Takashi Oshiba, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/520,814

(22) Filed: Sep. 14, 2006

(30) Foreign Application Priority Data
Sep. 15, 2005 (JP) 2005-268423

(51) Int. Cl. G06F 15/173

(52) U.S. Cl. 709/224

(57) ABSTRACT

A history information storage unit accumulates an interaction history which corresponds to each interaction session performed by a communication terminal and which at least contains the other-party user ID and the other-party terminal ID. If User A, who is interacting with the terminal b1 of User B, sends from the terminal 1a an interaction history request containing the ID of User B and the IDs of the other terminals a2 to an owned by User A, a history information computation unit searches, from the history information storage unit, the interaction histories for each interaction session respectively corresponding to the IDs of terminals a2 to an specified in the interaction history request to retrieve and send to the requesting terminal 1a interaction history containing the other-party user identifier matching the ID of User B.

### BACKGROUNDS OF THE INVENTION

1. Field of the Invention

The present invention relates to a communication system which has a function to manage histories of interaction sessions established between a plurality of communication terminals. More specifically, the present invention relates to a communication system which has a function to centrally manage interaction histories of different interaction sessions between a plurality of communication terminals owned by different users.

2. Description of the Related Art

A communication terminal, such as a cellular phone or an IP phone, typically has a function to store and manage histories of outgoing and incoming calls. This function allows the user to use the telephone number and other address information contained in an appropriate history to communicate with a terminal with which own terminal has previously interacted. This can simply be done by invoking the stored history on the display unit and then performing a calling operation.

Literature 1 proposes a communication terminal, wherein associations of users with email addresses and/or telephone numbers are recorded in the address book in advance; when, for example, the user operates an appropriate button while a received email is being displayed, the source email address is extracted from the received email, and the telephone number associated with the extracted email address is retrieved from the address book and displayed on the display unit. By this, the user can make a call to the displayed telephone number simply by pressing the call button.

Literature 2 proposes a communication system, wherein interaction histories for a plurality of communication terminals owned by a user are accumulated and managed using a history database on a server; when the user requests the interaction history from one of the communication terminals, the server reads out from the history database all the interaction histories of all the communication terminals owned by the user and send the information to the requesting terminal. The requesting terminal displays the received interaction histories on its display unit. The objects and effects of the art are unknown because Literature 2 provides no such description.

The most commonly used method to establish an interaction session between communication terminals is as follows. Either of the two communication terminals between which an interaction session will be established becomes an originating terminal and sends the address and other necessary information concerning the other terminal to a call control device. The call control device intermediates the establishment of the interaction session. There is another method that differs considerably from this one. It is called “third-party call control.” In this method, an interaction session between two communication terminals is established through an operation from a terminal other than these two communication terminals (refer to Literature 3 for examples). This method via third-party call control uses a unit called a “controller.” The controller intermediates between two terminals which will participate in an interaction session. The controller receives a third-party call control request from another terminal other than these two terminals. This request contains address information concerning the first two terminals. Using the information, the controller establishes an interaction session between one terminal and the other by performing call control therebetween. For clearer contrast with third-party call control, we will hereafter call the above-described commonly used method “normal call control.”

Literature 1 Japanese Patent Laying-Open No. 2001-94678

Literature 2 Japanese Patent Laying-Open No. 2001-249878

Literature 3 J. Rosenberg, J. Peterson, H. Schulzrinne, G. Camarillo, “Best Current Practices for Third Party Call Control (3pcc) in the Session Initiation Protocol (SIP)” IETF, April 2004, URL<http://www.ietf.org/rfc/rfc3725.txt>

It is recently becoming increasingly common for one user to own a plurality of communication terminals, such as telephone terminals, PC terminals and mobile terminals. The user often uses these plurality of communication terminals to communicate with another user by maintaining interaction sessions with the communication terminals owned by such another user. In this case, situations similar to the following may arise. One user (“User A”) is using a certain terminal (“terminal a1”) to interact with a certain terminal (“terminal b1”) of another user (“User B”). During this interaction, it may become necessary to establish a new interaction session between another terminal of User A (“terminal a2”) and another terminal of User B (“terminal b2”). For example, suppose Users A and B are interacting with each other using voice on telephone terminals. If they have difficulties in conveying their intentions, they may want to switch to a new interaction session between terminals which support communication using image and text in addition to voice, e.g., PC terminals.

The problem here is how User A can acquire the terminal ID and other address information concerning the other terminal b2 of User B. The most common way would be to directly ask User B using voice. This method is problematic because User A may hear the answer wrong or otherwise User B may remember it wrong. If User A has previously communicated with the terminal b2 of User B, then the most convenient way would be to see the interaction history for the terminal currently being used by User A, because the address information concerning the terminal b2 is recorded therein. It is cumbersome, however, to find histories for User B from numerous histories in the interaction history. If User A does not remember which terminal User A used to communicate with the terminal b2 of User B, User A must in the worst case go through all the terminals that User A owns to examine the interaction history stored in the storage area of each. This may mean lots of cumbersome efforts for users owning many terminals.

Using the art described in Literature 2, User A can operate from a currently using terminal a1 to capture, and display thereon, the interaction histories for all the terminals that User A owns. User A thus does not have to operate the individual terminals to reference the respective interaction histories. However, the problem still remains that User A has to find histories for User B from numerous histories in the interaction histories. In fact, User A has to find User B histories from even a larger number of histories, because the terminal a1 displays all the histories in all the interaction histories for all the terminals, including the terminal a1, which User A is currently using for this interaction session.

Suppose that User A is using a terminal a1 to interact with a terminal b1 of User B and that User A wants to continue the interaction with User B by establishing a new interaction session between another terminal of User A and another terminal of User B. In this case, another terminal of User A which will initiate a new interaction session is desirably in a physical proximity to the terminal a1. Similarly, another terminal of User B is desirably in a physical proximity to the terminal b1. User A would easily be able to determine which terminal among all the other terminals of User A is in a physical proximity to the terminal a1. However, it would generally be difficult for User A to select one terminal in a physical proximity to the terminal b1 from all the other terminals of User B, because User A does not know the physical locations of the terminals of User B, who is far at the other end of the line.

### SUMMARY OF THE INVENTION

The present invention is proposed to solve the above-described problems. One object of the present invention relates to the cases where User A, who owns a plurality of communication terminals, is using a communication terminal a1, to communicate with a communication terminal b1 of User B, who also owns a plurality of communication terminals. This object is in these cases to enable User A to easily browse the interaction histories between the other communication terminals of User A other than the communication terminal a1 and the other communication terminals of User B other than the communication terminal b1.

Another object of the present invention also relates to the cases where User A, who owns a plurality of communication terminals, is using a communication terminal a1 to communicate with a communication terminal b1 of User B, who also owns a plurality of communication terminals. This object is in these cases to enable User A to easily browse interaction history between the other communication terminals of User A other than the communication terminal a1 and, among the other communication terminals of User B other than the communication terminal b1, a communication terminal in a physical proximity to the communication terminal b1.

According to the first aspect of the invention, a communication system, comprises

a plurality of communication terminals owned by a plurality of users, a call control management device which intermediates the establishment of an interaction session between the communication terminals and a history management device which manages interaction histories are connected with each other through a communication network, wherein

the history management device including a history information storage unit which accumulates an interaction history corresponding to the identifiers of the communication terminals for an interaction session between the communication terminals, which interaction history containing at least the identifier of the other-party user and the identifier of the other-party terminal, a history information management unit which registers in the history information storage unit the interaction history, and a history information computation unit which receives from the communication terminal an interaction history request containing the identifier of the other-party user with which an interaction session has been established and the identifiers of the other communication terminals owned by the owner of own communication terminal, retrieves, from the history information storage unit, the interaction history for each interaction session respectively corresponding to the identifiers of the other communication terminals specified in the interaction history request, each of which contains the other-party user identifier matching the other-party user identifier specified in the interaction history request, and sends the retrieved interaction history and the corresponding identifiers of the communication terminals to the requesting communication terminal, wherein

the communication terminal including a history information processing unit which, when an operation to display interaction history is performed by the user while an interaction session with another communication terminal is being performed, sends to the history information computation unit an interaction history request containing the identifier of the other-party user with which an interaction session has already been established and the identifiers of the other communication terminals owned by the owner of own communication terminal, and displays on a display unit the interaction history received from the history information computation unit, together with the identifiers of the corresponding communication terminals.

In the preferred construction, the history management device includes a network information storage unit which stores overlapping relationships among logical networks from the perspective of physical installation locations, and the history information computation unit determines by referencing the network information storage unit a physical proximity between the logical network which includes the communication terminal currently performing an interaction session with the communication terminal which has sent the interaction history request belongs and the logical network which includes each of the communication terminals identified by the identifiers of the other-party terminals contained in the retrieved interaction histories, and sends the results of this determination to the requesting communication terminal.

In another preferred construction, the communication system further comprises a location management device which is capable of communicating with the plurality of communication terminals, and the location management device includes a user information storage unit which stores an association relationship between the identifier of the owner of the communication terminal and the identifier of the communication terminal, and a user information management unit which receives from the communication terminal a terminal identifier request containing the identifier of the owner of own communication terminal, retrieves from the user information storage unit the identifier of the communication terminal corresponding to the identifier of the owner contained in the terminal identifier request, and sends the retrieved identifier of the communication terminal to the requesting communication terminal.

In another preferred construction, the history management device includes a network information storage unit which stores overlapping relationships among logical networks from the perspective of physical installation locations, and the history information computation unit determines by referencing the network information storage unit a physical proximity between the logical network which includes the communication terminal currently performing an interaction session with the communication terminal which has sent the interaction history request and the logical network which includes each of the communication terminals identified by the identifiers of the other-party terminals contained in the retrieved interaction histories, and sends the results of this determination to the requesting communication terminal, a location management device which is capable of communicating with the plurality of communication terminals is provided, and the location management device includes a user information storage unit which stores an association relationship between the identifier of the owner of the communication terminal and the identifier of the communication terminal, and a user information management unit which receives from the communication terminal a terminal identifier request containing the identifier of the owner of own communication terminal, retrieves from the user information storage unit the identifier of the communication terminal corresponding to the identifier of the owner contained in the terminal identifier request, and sends the retrieved identifier of the communication terminal to the requesting communication terminal.

In another preferred construction, the call control management device includes a call transfer unit which receives from the communication terminal a third-party call control setting request containing the identifiers of two communication terminals desiring to establish an interaction session and then establishes an interaction session between the two communication terminals identified by the identifiers contained in the third-party call control setting request, and the communication terminal includes a communication data processing unit which sends to the call transfer unit a third-party call control setting request which contains, among the interaction histories displayed on the display unit and the corresponding identifiers of the communication terminals, the identifier of a communication terminal contained in the interaction history selected by the user and the identifier of the communication terminal corresponding to the selected interaction history.

In another preferred construction, the history management device includes a network information storage unit which stores overlapping relationships among logical networks from the perspective of physical installation locations, and the history information computation unit determines by referencing the network information storage unit a physical proximity between the logical network which includes the communication terminal currently performing an interaction session with the communication terminal which has sent the interaction history request and the logical network which includes each of the communication terminals identified by the identifiers of the other-party terminals contained in the retrieved interaction histories, and sends the results of this determination to the requesting communication terminal, the call control management device includes a call transfer unit which receives from the communication terminal a third-party call control setting request containing the identifiers of two communication terminals desiring to establish an interaction session and then establishes an interaction session between the two communication terminals identified by the identifiers contained in the third-party call control setting request, and the communication terminal includes a communication data processing unit which sends to the call transfer unit a third-party call control setting request which contains, among the interaction histories displayed on the display unit and the corresponding identifiers of the communication terminals, the identifier of a communication terminal contained in the interaction history selected by the user and the identifier of the communication terminal corresponding to the selected interaction history.

In another preferred construction, each interaction history stored in the history information storage unit further contains the identifier of the application used in the interaction session and the identifier of the content used in the application, the communication data processing unit sends to the call transfer unit the application identifier and content identifier contained in the selected interaction history by including in the third-party call control setting request, the call transfer unit sends to the two communication terminals desiring to establish an interaction session the identifier of the application and the identifier of the content which are to be used in the interaction session, and the communication terminal activates the application corresponding to the application identifier received from the call transfer unit, and is provided with an AP processing unit which displays on the display unit the content corresponding to the content identifier received from the call transfer unit.

In another preferred construction, the interaction history stored in the history information storage unit further contains the identifier of the application used in an interaction session and the setting information, the communication data processing unit sends to the call transfer unit the identifier of the application contained in the selected interaction history and setting information by including in the third-party call control setting request, the call transfer unit sends to the two communication terminals desiring to establish an interaction session the identifier of the application to be used in the interaction session and setting information, and the communication terminal activates the application corresponding to the application identifier received from the call transfer unit, and is provided with an AP processing unit which notifies the application setting information received from the call transfer unit to the application as activation parameters.

In another preferred construction, the application setting information at least contains either of skin ID or loudness level.

In another preferred construction, each interaction history stored in the history information storage unit further contains a send-and-receive type which indicates whether or not the interaction session was performed via third-party call control, the history information computation unit counts the occurrences of the send-and-receive type of third-party call control contained in the retrieved interaction histories for each identifier of the communication terminals corresponding to the retrieved interaction histories, and ranks the identifiers of the communication terminals corresponding to the retrieved interaction histories in the descending order of participation in interaction sessions via third-party call control.

According to the second aspect of the invention, a method of browsing interaction histories for a communication system wherein a plurality of communication terminals owned by a plurality of users, a call control management device which intermediates the establishment of an interaction session between the communication terminals and a history management device which manages interaction histories are connected with each other through a communication network, comprising the steps of

the history information management unit in the history management device registering an interaction history for each interaction session performed by the communication terminal, which at least contains the identifier of the other-party user and the identifier of the other-party terminal, in association with the identifier of the communication terminal,

when an operation to display interaction histories is performed by the user while an interaction session with another communication terminal is being performed, the communication terminal sending to the history information computation unit in the history management device an interaction history request which contains the identifier of the other-party user with which an interaction session has been established and the identifiers of the other communication terminals owned by the owner of own communication terminal,

the history information computation unit in the history management device receiving the interaction history request from the communication terminal, searching from the history information storage unit the interaction histories for each interaction session respectively corresponding to the identifiers of the other communication terminals specified in the interaction history request to retrieve interaction histories, each of which contains the other-party user identifier matching the other-party user identifier specified in the interaction history request, and sending the retrieved interaction histories and the identifiers of communication terminals corresponding to the requesting communication terminal,

and the communication terminal displaying on a display unit the interaction histories received from the history information computation unit, together with the identifiers of the corresponding communication terminals.

According to the third aspect of the invention, a history management device, wherein

being connected with a plurality of communication terminals owned by a plurality of users through a communication network, and

including a history information storage unit which accumulates interaction histories corresponding to the identifiers of the communication terminals, each of these interaction histories being an interaction history for an interaction session between the communication terminals and at least containing the identifier of the other-party user and the identifier of the other-party terminal,

a history information management unit which registers in the history information storage unit an interaction history for each interaction session performed by the communication terminals, and

a history information computation unit which receives from the communication terminal an interaction history request containing the identifier of the other-party user with which an interaction session has been established and the identifiers of the other communication terminals owned by the owner of own communication terminal, retrieves, from the history information storage unit, the interaction history for each interaction session respectively corresponding to the identifiers of the other communication terminals specified in the interaction history request, each of which contains the other-party user identifier matching the other-party user identifier specified in the interaction history request, and sends the retrieved interaction history and the corresponding identifiers of the communication terminals to the requesting communication terminal.

In the preferred construction, a network information storage unit which stores overlapping relationships among logical networks from the perspective of physical installation locations is provided, and the history information computation unit determines by referencing the network information storage unit a physical proximity between the logical network which includes the communication terminal currently performing an interaction session with the communication terminal which has sent the interaction history request and the logical network which includes each of the communication terminals identified by the identifiers of the other-party terminals contained in the retrieved interaction histories, and sends the results of this determination to the requesting communication terminal.

According to another aspect of the invention, a communication terminal, wherein

being connected with a history management device which manages interaction histories between a plurality of communication terminals through a communication network, and

including a history information processing unit which, when an operation to display interaction histories is performed by the user while an interaction session with another communication terminal is being performed, sends to the history management device an interaction history request containing the identifier of the other-party user with which an interaction session has already been established and the identifiers of the other communication terminals owned by the owner of own communication terminal, and, in response to the interaction history request, receives from the history management device, and displays on a display unit, the interaction histories and the identifiers of the corresponding communication terminals.

According to a further aspect of the invention, a communication terminal, wherein

being connected with a history management device which manages interaction histories between a plurality of communication terminals through a communication network, and

including a history information processing unit which, when an operation to display interaction histories is performed by the user while an interaction session with another communication terminal is being performed, sends to the history management device an interaction history request containing the identifier of the other-party user with which an interaction session has already been established and the identifiers of the other communication terminals owned by the owner of own communication terminal, in response to the interaction history request, receives from the history management device an interaction history and the corresponding communication terminal identifier, together with the results of determining a physical proximity between the logical network which includes the communication terminal with which own current terminal has established an interaction session and the logical network which includes the communication terminal identified by the identifier of the other-party terminal contained in the received interaction history, displays a list of the identifiers of the other-party terminals for each of the received identifiers of own communication terminals contained in each of the corresponding interaction histories, arranged in ascending order of distance to the other-party communication terminal which is currently performing an interaction session, and, when one of the own communication terminal identifiers displayed and one of the corresponding other-party communication terminal identifiers on the list are selected by the user, displays the interaction history between these two selected communication terminals.

According to the present invention, in the cases where User A, who owns a plurality of communication terminals, is using a communication terminal a1 to communicate with a communication terminal b1 of User B, who also owns a plurality of communication terminals, if a request for interaction history is issued by User A by operating the communication terminal a1, an interaction history request, which specifies the identifiers of the other communication terminals owned by User A and the identifier of the User B terminal with which User A is currently maintaining an interaction session, is sent to a history management device. At the history management device, the interaction histories for each of the interaction sessions respectively corresponding to the identifiers of the other communication terminals specified in the interaction history request are searched from the history information storage unit to retrieve interaction histories, each of which contains the other-party user identifier matching the other-party user B identifier specified in the interaction history request. The retrieved interaction histories are sent to the requesting terminal, i.e., terminal a1, and displayed on the display unit of the communication terminal a1.

According to the present invention, in the cases where User A, who owns a plurality of communication terminals, is communicating using a communication terminal a1 with a communication terminal b1 of User B, who also owns a plurality of communication terminals, it becomes easier for User A to browse the interaction histories between the other communication terminals of User A other than the communication terminal a1 and the other communication terminals of User B other than the communication terminal b1. One reason for this is that the interaction histories which User A has to browse are limited to those between User A and User B, thereby eliminating the efforts on the part of User A to find interaction histories for User B from those for all users including User B. Another reason is that interaction histories between the communication terminal a1, which is being used for the current interaction session, and User B are excluded from the interaction histories to be browsed by User A.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram for a first aspect of the present invention;

FIG. 2 is a block diagram for a second aspect of the present invention;

FIG. 3 is a schematic configuration diagram for a first embodiment of the present invention;

FIG. 4 is a principal block diagram for the first embodiment of the present invention;

FIG. 5 is a configuration diagram for an interaction session information table used in the first embodiment of the present invention;

FIG. 6 is a configuration diagram for a user information table and a terminal ID table used in the first embodiment of the present invention;

FIG. 7 is a configuration diagram for a terminal information table and an available AP table used in the first embodiment of the present invention;

FIG. 8 is a configuration diagram for a history information table, an individual history table, a history content table and a used content table used in the first embodiment of the present invention;

FIG. 9 is a configuration diagram for a terminal setting information table and an other terminal table used in the first embodiment of the present invention;

FIG. 10 is a configuration diagram for an AP setting information table and an available AP table used in the first embodiment of the present invention;

FIG. 11 is a configuration diagram for a content table used in the first embodiment of the present invention;

FIG. 12-1 is a flow chart illustrating the operation of a normal call control process according to the first embodiment of the present invention;

FIG. 12-2 is a flow chart illustrating the operation of a normal call control process according to the first embodiment of the present invention;

FIG. 13-1 is a flow chart illustrating the operation of a normal call control and third-party call control process according to the first embodiment of the present invention;

FIG. 13-2 is a flow chart illustrating the operation of a normal call control and third-party call control process according to the first embodiment of the present invention;

FIG. 13-3 is a flow chart illustrating the operation of a normal call control and third-party call control process according to the first embodiment of the present invention;

FIG. 14 is a flow chart illustrating the details of computation of history information according to the first embodiment of the present invention;

FIG. 15 is a principal block diagram for a first embodiment of the present invention;

FIG. 16 is a configuration diagram for a network information table and a weight parameter table used in the second embodiment of the present invention;

FIG. 17-1 is a flow chart illustrating the operation of a normal call control and third-party call control process according to the second embodiment of the present invention;

FIG. 17-2 is a flow chart illustrating the operation of a normal call control and third-party call control process according to the second embodiment of the present invention;

FIG. 17-3 is a flow chart illustrating the operation of a normal call control and third-party call control process according to the second embodiment of the present invention;

FIG. 18 is a flow chart illustrating the details of computation of history information according to the second embodiment of the present invention;

FIG. 19 is a diagram showing a practical example of an interaction history according to the first embodiment of the present invention;

FIG. 20 is an explanatory diagram showing a computation process for interaction information according to the first embodiment of the present invention;

FIG. 21 is an explanatory diagram showing a computation process for interaction information according to the first embodiment of the present invention;

FIG. 22 is a diagram showing a display example of an interaction history according to the first embodiment of the present invention; and

FIG. 23 is a diagram showing a display example of an interaction history according to the second embodiment of the present invention.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

(First Aspect)

A first aspect of the present invention will now be described in detail by referring to the drawings.

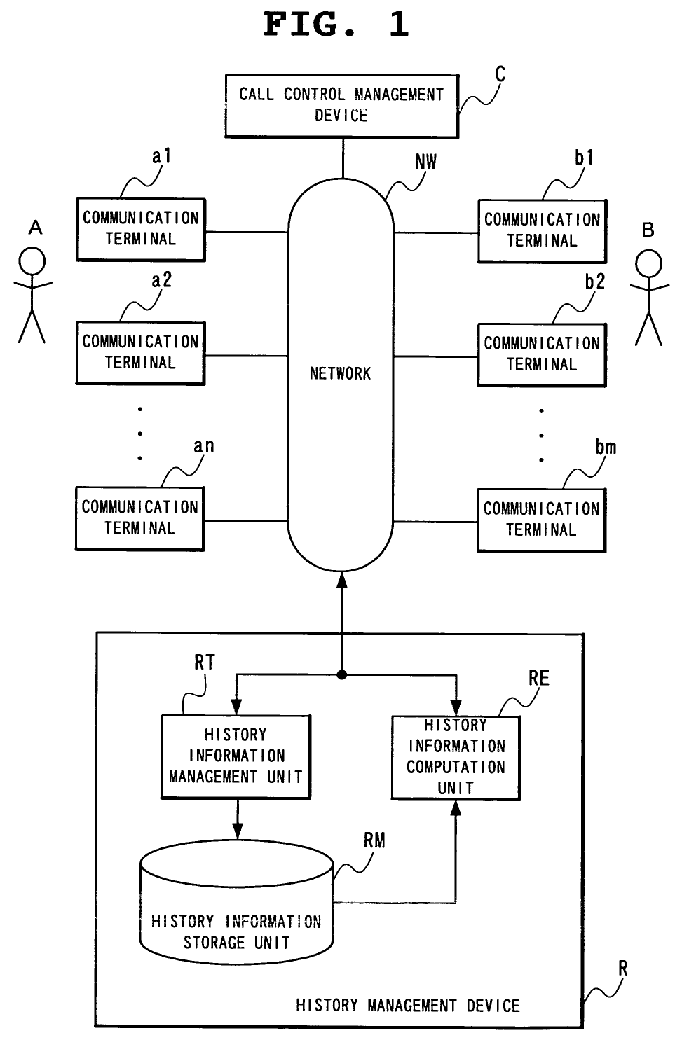

With reference to FIG. 1, in a communication system according to the first aspect of the present invention, a plurality of communication terminals a1 to an and communication terminals b1 to bm which are owned by a plurality of users, Users A and B, a call control management device C which intermediates the establishment of interaction sessions between these communication terminals, and a history management device R which manages interaction histories are connected among one another via a communication network NW in a communicable manner.

The history management device R has a history information storage unit RM which accumulates interaction histories corresponding to the identifiers of the communication terminals, each of these interaction histories being an interaction history for an interaction session between any of communication terminals a1 to an and any of communication terminals b1 to bm and at least containing the identifier of the other-party user and the identifier of the other-party terminal; a history information management unit RT which collects an interaction history for each of the interaction sessions between any of communication terminals a1 to an and any of communication terminals b1 to bm from, for example, the communication terminal on which the interaction session is being performed or from a call control management device C, and registers the collected interaction history in a history information storage unit RM; and a history information computation unit RE which, on receiving from any of communication terminals a1 to an or communication terminals b1 to bm an interaction history request containing the identifier of the other-party user with which an interaction session is currently being performed and the identifiers of the other communication terminals owned by the owner of own communication terminal, searches, from a history information storage unit RM, the interaction histories for each of the interaction sessions respectively corresponding to the identifiers of the other communication terminals specified in the interaction history request to retrieve interaction histories, each of which contains the other-party user identifier matching the other-party user identifier specified in the interaction history request, and sends the retrieved interaction histories and the identifiers of communication terminals corresponding thereto to the requesting communication terminal.

In addition to communication functions, such as telephone and electronic conference, each of the communication terminals a1 to an and the communication terminals b1 to bm has a function which, when an operation to display interaction histories is performed by the user while an interaction session with another communication terminal is being performed, sends to the history information computation unit RE an interaction history request containing the identifier of the other-party user with which an interaction session has already been established and the identifiers of the other communication terminals owned by the owner of own communication terminal and then displays on its display unit the interaction histories received from the history information computation unit RE, together with the identifiers of the communication terminals corresponding thereto.

The call control management device C is preferably provided with a third-party call control function.

This communication system according to the first aspect operates as described below.

When User A and User B interacts with each other by establishing an interaction session through the network NW through use of any of the communication terminals, for example, a communication terminal a2 and a communication terminal b2, an interaction history therefor is collected by the history information management unit RT and saved in the history information storage unit RM. More specifically, an interaction history at least containing the identifier of the other-party user, User B, and the identifier of the other-party terminal b2 is saved as a new interaction history corresponding to the identifier of the communication terminal a2, while an interaction history at least containing the identifier of the other-party user, User A, and the identifier of the other-party terminal a2 is saved as a new interaction history corresponding to the identifier of the communication terminal b2. Similarly thereafter, as interaction sessions take place between any of the communication terminals, interaction histories respectively corresponding to these interaction sessions are accumulated in the history information storage unit RM.

Then, if for example User A performs an operation to display interaction histories while User A is interacting with communication terminal b1 of User B by using a communication terminal a1, the communication terminal a1 sends an interaction history request which contains the identifier of the other-party user, User B, with which an interaction session is currently being performed, and the identifiers of the other communication terminals a2 to an owned by User A to the history information computation unit RE through the network NW. The history information computation unit RE searches, from the history information storage unit RM, the interaction histories for each of the interaction sessions respectively corresponding to the identifiers of the other communication terminals a2 to an specified in the received interaction history request to retrieve interaction histories, each of which contains the other-party user identifier matching the other-party user B identifier specified in the interaction history request, and sends the retrieved interaction histories together with the identifiers of the communication terminals a2 and an corresponding thereto to the requesting terminal a1. The communication terminal a1 displays the received interaction histories and the identifiers of the communication terminals a2 to an corresponding thereto on the display unit.

Thus, according to this embodiment, while User A, who owns a plurality of communication terminals a1 to an, is communicating with a communication terminal b1, which is one of the communication terminals owned by User B who owns a plurality of communication terminals b1 to bm, by using a communication terminal a1, which is one of the communication terminals that User A owns, User A can easily browse the histories for interactions between User A's other communication terminals other than the communication terminal a1, i.e., communication terminals a2 to an, and User B's other communication terminals other than the communication terminal b1, i.e., communication terminals b2 to bm.

When User A selects any of the interaction histories displayed on the display unit, for example a history concerning an interaction between the communication terminal a2 and the communication terminal b2, and performs an operation to request third-party call control, a third-party call control setting request which contains the identifiers of the communication terminals a2 and b2 is sent from the communication terminal a1 to the call control management device C. By this, an interaction session is established between these two communication terminals, a2 and b2, under the control of the call control management device C. In this situation, Users A and B can switch the current interaction session to a new interaction session using other communication terminals.

The description above assumes that User A knows the identifiers of his or her own communication terminals a2 to an other than the communication terminal a1. However, some users may not know the identifiers of all of their own terminals. For these users, a location management device may be provided which, on receiving from a communication terminal a terminal identifier request containing a user identifier, responds to the request with the identifiers of all the terminals of that user. The description above assumes that an interaction history includes the identifier of the other-party user and the identifier of the other-party terminal. In addition to these, the interaction history may contain application setting information, such as start and end times of the interaction session, identifier of the application used for the interaction session, identifier of the content used in the application, skin ID which defines the screen layout of the application and loudness level.

(Second Aspect)

A second aspect of the present invention will now be described in detail by referring to the drawings.

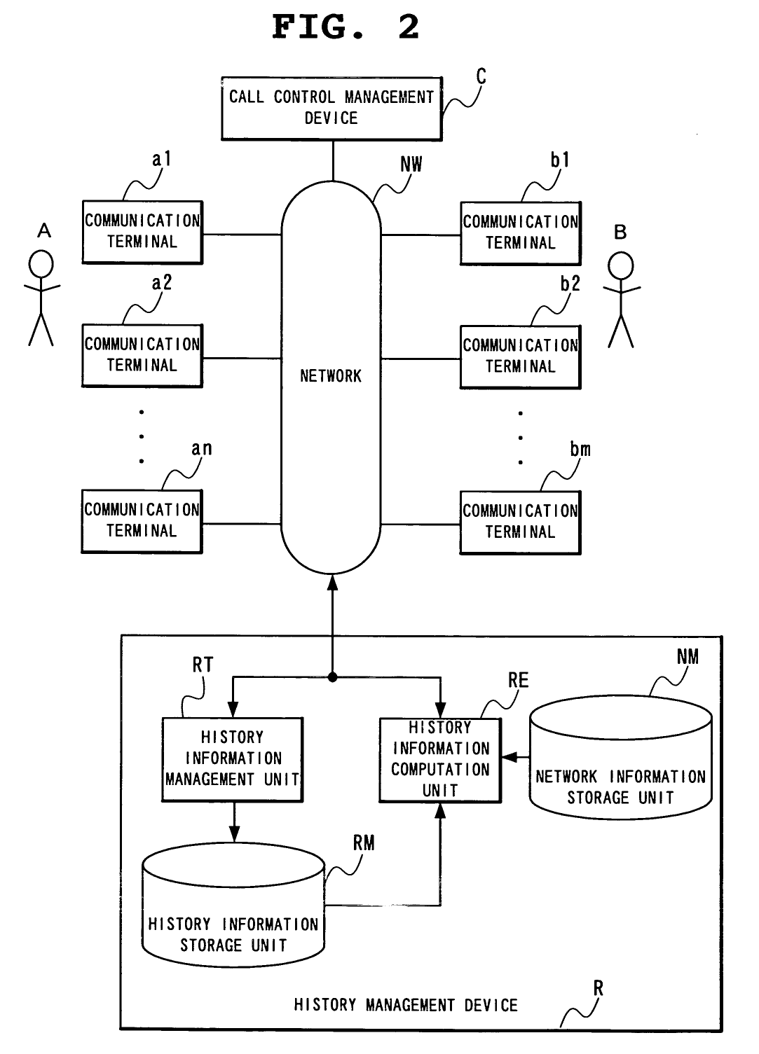

With reference to FIG. 2, a communication system according to the second aspect of the present invention differs from the communication system according to the first aspect in that the history management device R has a network information storage unit NM and that there are some differences in the function of the history information computation unit RE.

The network information storage unit NM stores overlapping relationships among logical networks from the perspective of physical installation locations.

The history information computation device RE has, in addition to the function of the history information computation unit RE according to the first aspect, a function to determine whether or not the logical network to which a communication terminal belongs and the logical network to which another communication terminal belongs are in a physical proximity by referencing the network information storage unit NM.

This communication system according to the second aspect operates as described below.

The operation of the communication system is the same as the first aspect in that, as interaction sessions take place between any of the communication terminals, interaction histories respectively corresponding to these interaction sessions are accumulated in the history information storage unit RM.

Then, if for example User A performs an operation to display interaction histories while User A is interacting with a communication terminal b1 of User B by using a communication terminal a1, the communication terminal a1 sends to the history information computation unit RE through the network NW an interaction history request which contains the identifier of the other-party user, User B, with which an interaction session is currently being performed, and the identifiers of the other communication terminals a2 to an owned by User A. The history information computation unit RE searches, from the history information storage unit RM, the interaction histories for each of the interaction sessions respectively corresponding to the identifiers of the other communication terminals a2 to an specified in the received interaction history request to retrieve interaction histories, each of which contains the other-party user identifier matching the other-party user B identifier specified in the interaction history request.

The history information computation unit RE then references the network information storage unit NM to determine the physical proximity between the logical network, to which the communication terminal b1 that is currently maintaining an interaction session with the sender of the interaction request, i.e., communication terminal a1, belongs and the logical network to which the other-party terminal b2 to bm contained in the retrieved interaction history belongs. The history information computation unit RE then sends to the requesting communication terminal a1 the retrieved interaction history, the identifier of the corresponding communication terminal a2 to an and the content of the determination made above.

The communication terminal a1 displays for each identifier of the received communication terminals a2 to an a list which contains the identifiers of the other-party terminal b2 to bm appearing in the interaction histories corresponding to the identifier, arranged in ascending order of distance to the terminal b1. When any one of the displayed identifiers of the communication terminals a2 to an and any one of the identifier of the terminal b2 to bm in the list corresponding thereto are selected by the user, the communication terminal a1 displays the interaction history between these two selected communication terminals.

Thus, according to this embodiment, while User A, who owns a plurality of communication terminals a1 to an, is communicating with a communication terminal b1, which is one of the communication terminals owned by User B who owns a plurality of communication terminals b1 to bm, by using a communication terminal a1, which is one of the communication terminals that User A owns, User A can easily browse the histories for interactions between User A's other communication terminals other than the communication terminal a1, i.e., communication terminals a2 to an, and User B's other communication terminals other than the communication terminal b1, i.e., communication terminals b2 to bm, and also can recognize which of the communication terminals b2 to bm is in a physical proximity to the current other-party terminal b1.

When User A selects any of the interaction histories displayed on the display unit, for example a history concerning an interaction between a communication terminal a2 known to be located in proximity to the communication terminal a1 and a communication terminal b2 found to be in proximity to the communication terminal b1, and performs an operation to request third-party call control, then a third-party call control setting request which contains the identifiers of the communication terminals a2 and b2 is sent from the communication terminal a1 to the call control management device C. By this, an interaction session is established between these two communication terminals, a2 and b2, under the control of the call control management device C. In this situation, User A and User B can switch the current interaction session to a new interaction session in which other communication terminals in proximity are used.

While the description above assumes that User A knows the physical proximity between the communication terminal a1 of User A and each of the other communication terminals a2 to an, it is possible to determine the physical proximity between these communication terminals as is done with the communication terminal b1 and each of the communication terminals b2 to bm.

### First Embodiment

An embodiment according to the first aspect of the present invention will now be described in detail by referring to the drawings.

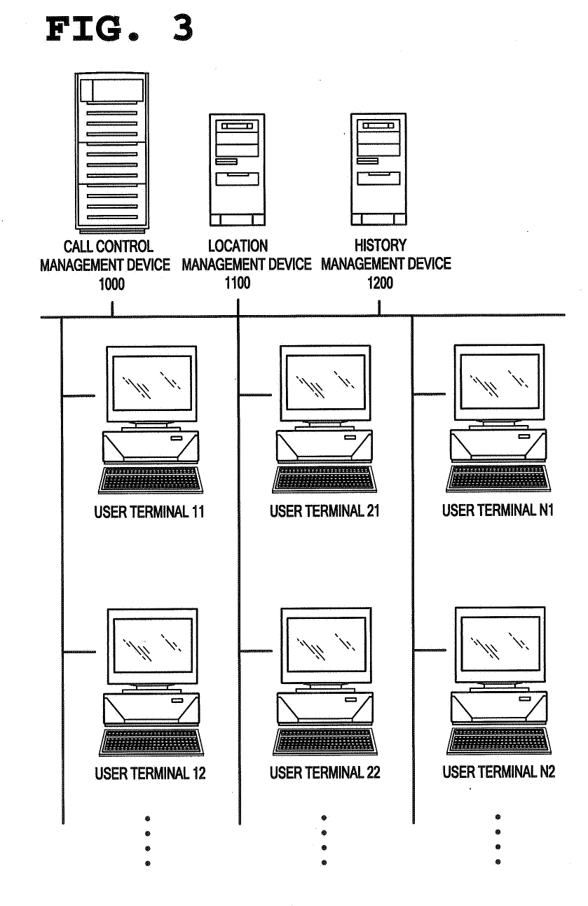

With reference to FIG. 3, in a communication system according to the first embodiment of the present invention, a call control management device 1000, a location management device 1100 and a history management device 1200 are connected with a user terminal 11, user terminal 12 . . . , user terminal 21, user terminal 22 . . . , user terminal N1, and user terminal N2 . . . , all in a mutually communicable manner, through a communication network, such as the Internet.

In the description above, “N” represents the total number of users. “User terminal 11, user terminal 12 . . . ” are the communication terminals owned by User A. “User terminal 21, user terminal 22 . . . ” are the communication terminals owned by User B. “User terminal N1, user terminal N2 . . . ” are the communication terminals owned by the Nth user.

A user terminal may be an IP phone, cellular phone, personal computer (PC), portable computer (PDA: Personal Digital Assistance), street multi-media terminal, vehicle-mounted terminal, TV with a network connection function, set-top box with a network connection function, game machine with a network connection function or any other similar device with a function to exchange information with outside world.

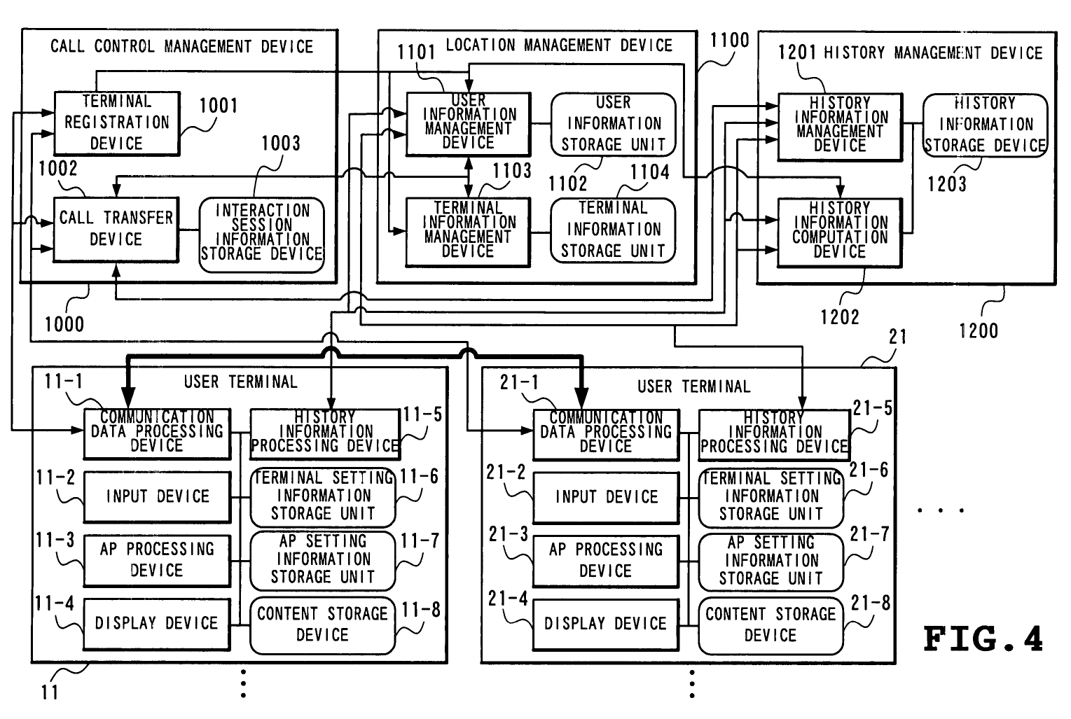

FIG. 4 shows example internal configurations of a call control management device 1000, a location management device 1100, a history management device 1200 and user terminals 11 and 21. Other user terminals, such as user terminals 12, 22, have approximately the same configuration as the user terminals 11, 21.

(Description of Call Control Management Device 1000)

The call control management device 1000 has a terminal registration device 1001, a call transfer device 1002 and an interaction session information storage device 1003.

The terminal registration device 1001 receives, from each user terminal, information concerning the user and user terminal (for example, user ID and terminal ID; or terminal ID, terminal address and available AP list), and sends the received information to the user information management device 1101 and terminal information management device 1103 of the location management device 1100, thereby performing the operation to register information concerning each user terminal in place of the respective user terminals.

The call transfer device 1002 receives information necessary for setting a call from the source user terminal (in the case of normal call control) or the user terminal which is requesting third-party call control (in the case of third-party call control), sets a call between the source and destination user terminals and starts an interaction session. At the start of the interaction session, the call transfer device 1002 updates the information in the interaction history for the source and destination user terminals by sending information concerning the interaction session to the history information management device 1201 of the history management device 1200.

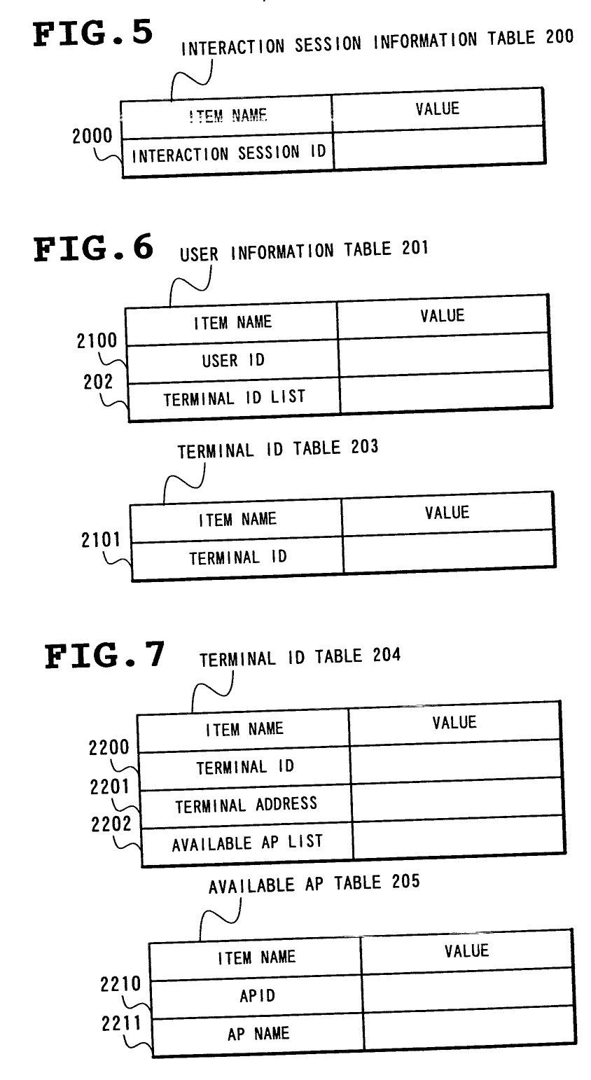

The interaction session information storage device 1003 stores a plurality of interaction session information tables 200, as shown in FIG. 5. Each interaction session information table 200 stores one interaction session ID 2000. The interaction session ID 2000 is used to identify an interaction session.

(Description of Location Management Device 1100)

The location management device 1100 has a user information management device 1101, a user information storage unit 1102, a terminal information management device 1103 and a terminal information storage unit 1104.

The user information management device 1101 manages an association relationship between user and user terminal by receiving a user ID and terminal ID from the terminal registration device 1001 of the call control management device 1000 and storing the received information in the user information storage unit 1102. The user information management device 1101 has a function to receive a user ID and replies with all the terminal IDs corresponding to that user ID. This function can only be used if the association relationship between user ID and terminal ID stored in the below-described terminal setting information storage unit 11-6, 21-6 is also retained between the user ID and terminal ID stored in the user information storage unit 1102. The reason for providing this access control function is to allow a user to acquire, from the user terminal that he or she owns, the terminal IDs of the other user terminals that he or she owns by using his or her own user ID as a key, but to prevent the user from acquiring the terminal IDs of the terminals owned by another user using the user ID of such another user as a key.

The user information storage unit 1102 stores at maximum an N number of user information tables 201, as shown in FIG. 6. Each user information table 201 stores one each of user ID 2100 and terminal ID list 202. The user ID 2100 is used to identify a user. The terminal ID list 202 stores a plurality of terminal ID tables 203, as shown in FIG. 6. Each terminal ID table 203 stores one terminal ID 2101. The terminal ID 2101 is used to identify a user terminal. As mentioned above, “N” represents the total number of users. By this, an association relationship between user and terminal, i.e., which user owns how many user terminals and what the terminal IDs of these user terminals are, is managed.

The terminal information management device 1103 manages an association relationship among user terminal, terminal address and available AP list by receiving a terminal ID, terminal address and available AP list from the terminal registration device 1001 of the call control management device 1000 and storing the received information in the terminal information storage unit 1104.

The terminal information storage unit 1104 stores a plurality of terminal information tables 204, as shown in FIG. 7. Each terminal information table 204 stores one each of terminal ID 2200, terminal address 2201 and available AP list 2202. The number of these terminal information tables 204 is the same as the number of the terminal IDs 2101 stored in the user information storage unit 1102 (=the number of tables 203). The terminal ID 2200 is used to identify a user terminal. The terminal address 2201 is the network address information concerning the corresponding terminal ID 2200. This may be an IP address, MAC address or other similar address information. The available AP list 2202 stores a plurality of available AP tables 205, as shown in FIG. 7. Each available AP table 205 stores one each of APID 2210 and AP name 2211. The APID 2210 is used to identify an application available in an interaction session (for example, a telephone, electronic conference or softphone). The AP name 2211 is an alias of an APID 2210 assigned to make the APID 2210 more user-friendly.

(Description of History Management Device 1200)

The history management device 1200 has a history information management device 1201, a history information computation device 1202 and a history information storage device 1203.

The history information management device 1201 manages an interaction session history for each user terminal in terms of which user terminal performed an interaction session when and with which user terminal by using which application.

The history information computation device 1202 performs a ranking process as described below on the information contained in interaction session histories and sends the computation results to the history information processing device 11-5, 21-5 in the user terminal.

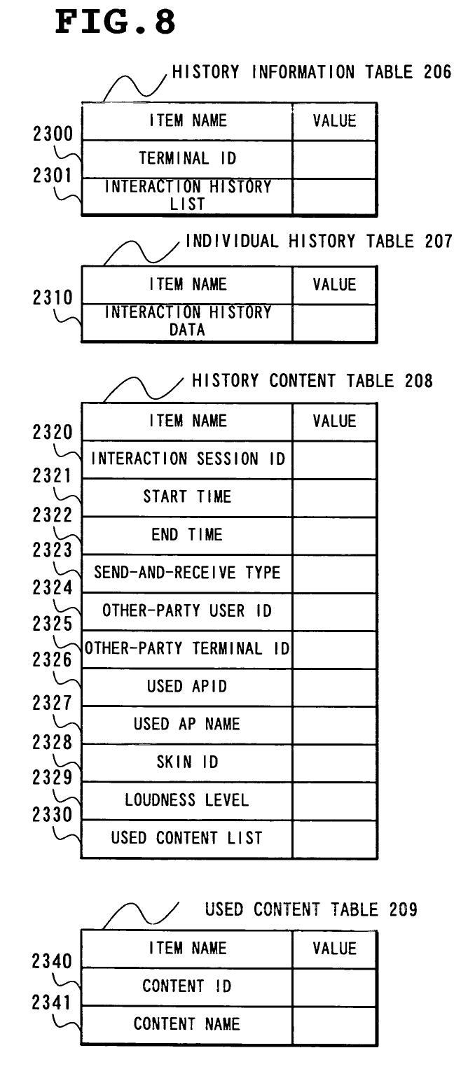

The history information storage unit 1203 stores a plurality of history information tables 206, as shown in FIG. 8. Each history information table 206 stores one each of terminal ID 2300 and interaction history list 2301. The terminal ID 2300 is used to identify a user terminal. The interaction history list 2301 stores a plurality of individual history tables 207, as shown in FIG. 8. The number of these individual history tables 207 is the same as the number of interaction sessions in which the corresponding user terminal participated in the past. The individual history table 207 stores a set of interaction history data 2310. The interaction history data 2310 holds one history content table 208, as shown in FIG. 8.

The history content table 208 stores one each of interaction session ID 2320, start time 2321, end time 2322, send-and-receive type 2323, other-party user ID 2324, other-party terminal ID 2325, used APID 2326, used AP name 2327, skin ID 2328, loudness level 2329 and used content list 2330.

The interaction session ID 2320 is used to identify an interaction session. The start time 2321 represents the time when the interaction session started. The end time 2322 represents the time when the interaction session ended. The send-and-receive type 2323 represents the type of how a user terminal was involved in an interaction session when a call for that interaction session was set. Examples include whether the user terminal participated in the interaction session as a source terminal via normal call control or as a destination terminal via normal call control, or otherwise the user terminal participated in the interaction session via third-party call control. The effective value for the send-and-receive type 2323 can be any of “outgoing,” “incoming” and “third-party call control.” The other-party user ID 2324 stores the user ID of the user who owns the user terminal which was the other party to the interaction session. The other-party terminal ID 2325 stores the terminal ID of the user who was the other party to the interaction session. The used APID 2326 stores the ID of the application used in the interaction session. The used AP name 2327 is an alias of a used APID 2326 assigned to make the APID 2326 more user-friendly. The skin ID 2328 is used to identify the skin of the application which was used in the interaction session. Some types of used APID 2326 may not have any skin ID 2328. The loudness level 2329 is used to identify the level of the loudness used in the interaction session. Some types of used APID 2326 may not have any loudness level 2329. The used content list 2330 stores a plurality of used content tables 209, as shown in FIG. 8. The number of used content tables 209 is the same as the number of contents used in the interaction session. Each used content table 209 stores each one of content ID 2340 and content name 2341. The content ID 2340 is used to identify the content which was used in the interaction session. The content name 2341 is an alias of a content name 2340 assigned to make the content ID 2340 more user-friendly.

(Description of User Terminal)

A description of a user terminal 11 is provided below. A description of user terminals other than the user terminal 11 is omitted because the constitution and operation of each are the same as the user terminal 11.

The user terminal 11 has a communication data processing device 11-1, an input device 11-2, an AP processing device 11-3, a display device 11-4, a history information processing device 11-5, a terminal setting information storage unit 11-6, an AP setting information storage unit 11-7 and a content storage device 11-8. The components in each user terminal other than the user terminal 11 are assigned reference marks accompanied by branch numbers similar to the user terminal 11. For example, the input device in the user terminal 21 is assigned a reference mark of 21-2, while the input device of the user terminal is assigned a reference mark of 12-2.

The input device 11-2 is used to input information in and operate the communication data processing device 11-1, the history information processing device 11-5 and other devices with similar functions.

The communication data processing device 11-1 is used to send information concerning users and user terminals to the terminal registration device 1001, call requests for setting calls to the call transfer device 1002, and information concerning applications used in interaction sessions to the AP processing device 11-3. Interaction functions, such as softphone and other telephone functions and video conference functions, are implemented on this communication data processing device 11-1. Illustrations of a telephone transmitter, telephone receiver and camera, which are needed for making voice calls, are omitted from the drawings attached hereto.

The history information processing device 11-5 is used to send the information in an interaction history to the history management device 1200 on completion of an interaction session and to compile or sort the information in the interaction history.

The display device 11-4 is used to display the other terminal IDs held by the terminal setting information storage unit 11-6 in order to enable the user to perform send operations, to display the screen of an application being used by the user while the user is participating in an interaction session so that the user can operate the application and to display the interaction histories received from the history information processing device 11-5 while the user is participating in an interaction session so that the user can perform third-party call control.

The AP processing device 11-3 is used to receive from the communication data processing device 11-1 a request for the activation of the application specified by an APID as well as a request for the reading of the content specified by a content ID, to acquire application setting information from the AP setting information storage unit 11-7, to activate the application after reading the content data from the content storage device 11-8 and to display the application screen on the display device 11-4.

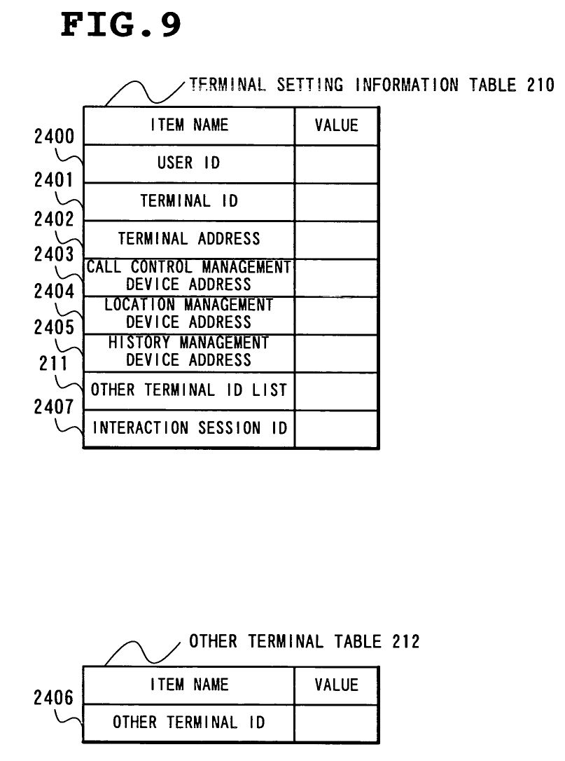

The terminal setting information storage unit 11-6 stores one terminal setting information table 210, as shown in FIG. 9. The terminal setting information table 210 stores one each of user ID 2400, terminal ID 2401, terminal address 2402, call control management device address 2403, location management device address 2404, history management device address 2405, other terminal ID list 211 and interaction session ID 2407. The user ID 2400 is used to identify the user who owns this user terminal. The terminal ID 2401 is used to identify this user terminal. The terminal address 2402 is the network address information concerning this user terminal ID. The call control management device address 2403 is the network address information concerning the call control management device 1000, which information becomes necessary for this user terminal to register information concerning itself. The location management device address 2404 is the network address information for the location management device 1100, which information becomes necessary for this user terminal to search the information concerning the other user terminals owned by the user who owns this user terminal. The history management device address 2405 is the network address information concerning the history management device 1200, which information becomes necessary for this user terminal to register its own interaction history. The interaction session ID 2407 is used to identify an interaction session. The other terminal ID list 211 stores a plurality of other terminal tables 212, as shown in FIG. 9. Each other terminal table 212 stores other terminal IDs 2406. The other terminal ID 2406 is used to make an outgoing call to another user terminal. This means that the other terminal ID list 211 is used as an electronic address book. The terminal setting information storage unit 11-6 can store a plurality of other terminal IDs 2406, but it may not necessarily store the terminal IDs of all other user terminals. Typically, the terminal IDs of only some of the existing user terminals are stored. In addition, the other terminal IDs 2406 stored in a plurality of different user terminals owned by one user may not necessarily be identical to one another. Other terminal IDs 2406 stored in a certain user terminal may possibly not be stored in some or all of the other user terminals owned by the same user. Among the above-listed information held in the terminal setting information table 210, the user ID 2400, terminal ID 2401, terminal address 2402, call control management device address 2403, location management device address 2404 and history management device address 2405 are set by the input device 11-2 during, for example, the initialization of this user terminal.

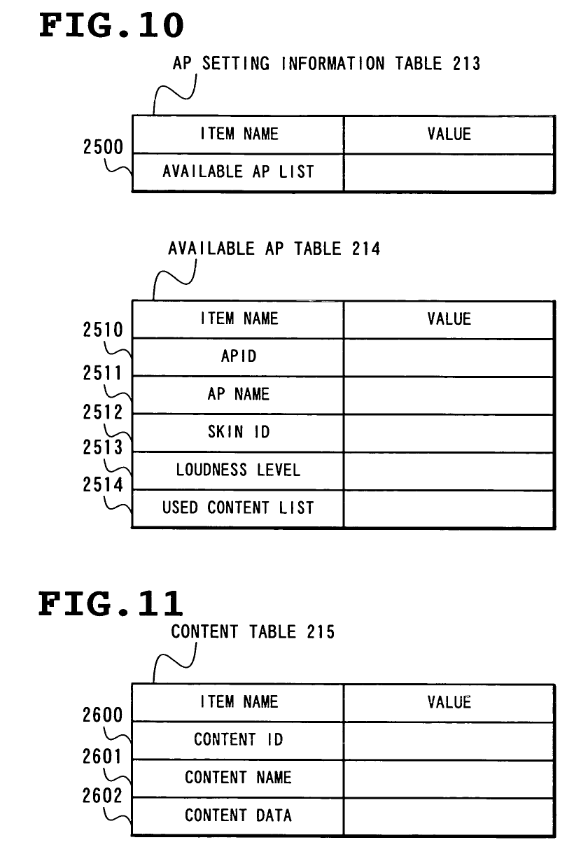

The AP setting information storage unit 11-7 stores one AP setting information table 213, as shown in FIG. 10. The AP setting information table 213 stores one available AP list 2500. The available AP list 2500 stores a plurality of available AP tables 214, as shown in FIG. 10. Each available AP table 214 stores one each of APID 2510, AP name 2511, skin ID 2512, loudness level 2513 and used content list 2514. The APID 2510 is used to identify an application operable on this user terminal. The AP name 2511 is an alias of an APID 2510 assigned to make the APID 2510 more user-friendly. The skin ID 2512 is used to specify to an application in what screen layout it should display the screen. A “skin” herein is a definition of the portion of a screen display which a screen displaying application should display. By specifying a skin ID 2512, the application is enabled to perform screen display according to the screen layout defined by that skin ID 2512. Some types of APID 2510 may not have any skin ID 2512. The loudness level 2513 is used to specify to an application at what loudness level the application should regenerate voice. Some types of APID 2510 may not have any loudness level ID 2513. The used content list 2514 stores a pair of content ID and content name which were used in an interaction session performed by utilizing this application.

The content storage device 11-8 stores a plurality of content tables 215, as shown in FIG. 11. Each content table 215 stores one each of content ID 2600, content name 2601 and content data 2602. The content ID 2600 is used to identify the plurality of contents held by this user terminal. The content ID 2600 may be a GU ID or other similar identifier. The content name 2601 is an alias of a content ID 2600 assigned to make the corresponding content ID 2600 more user-friendly. The content data 2602 is the data body of the content held by this user terminal.

The operation of this embodiment will now be described in detail.

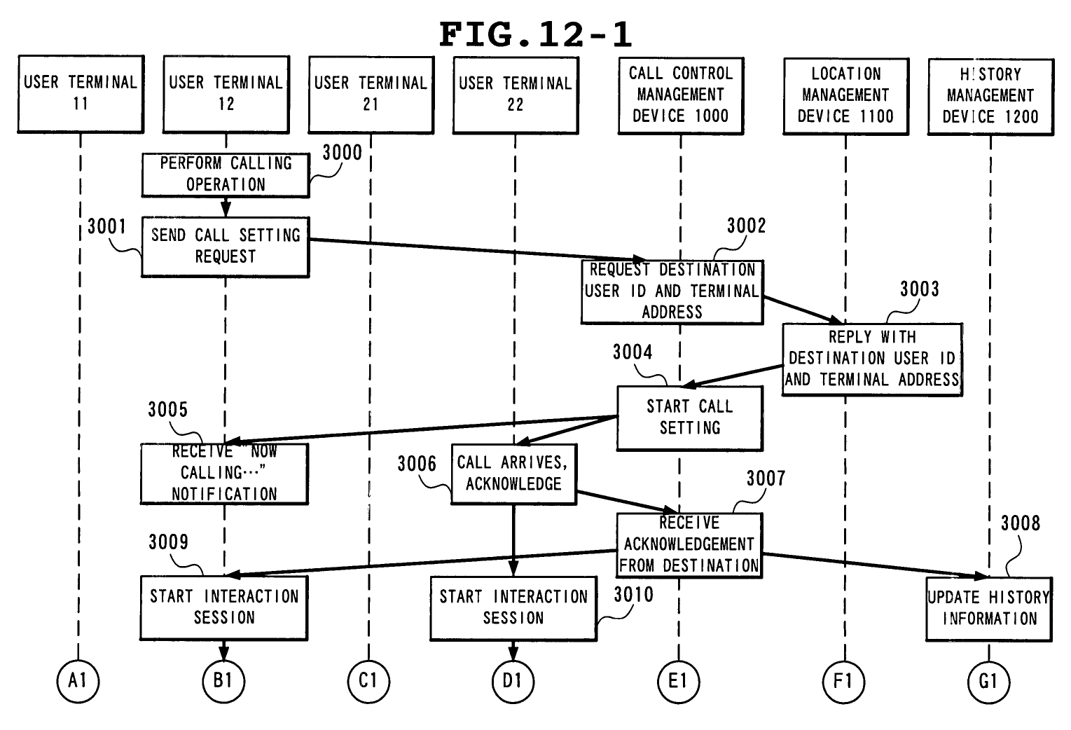

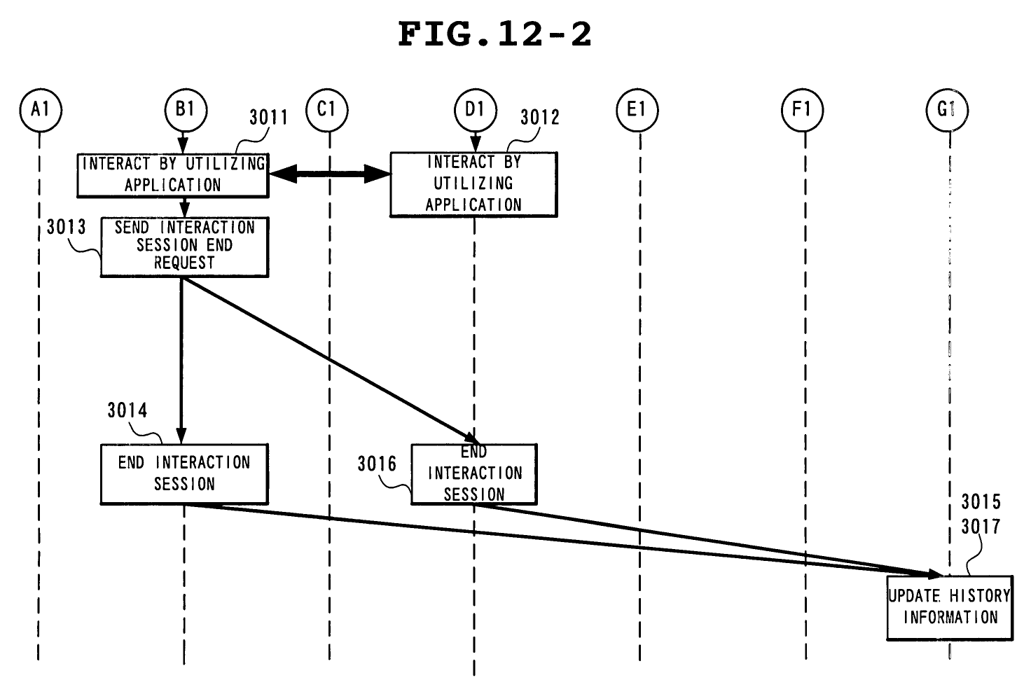

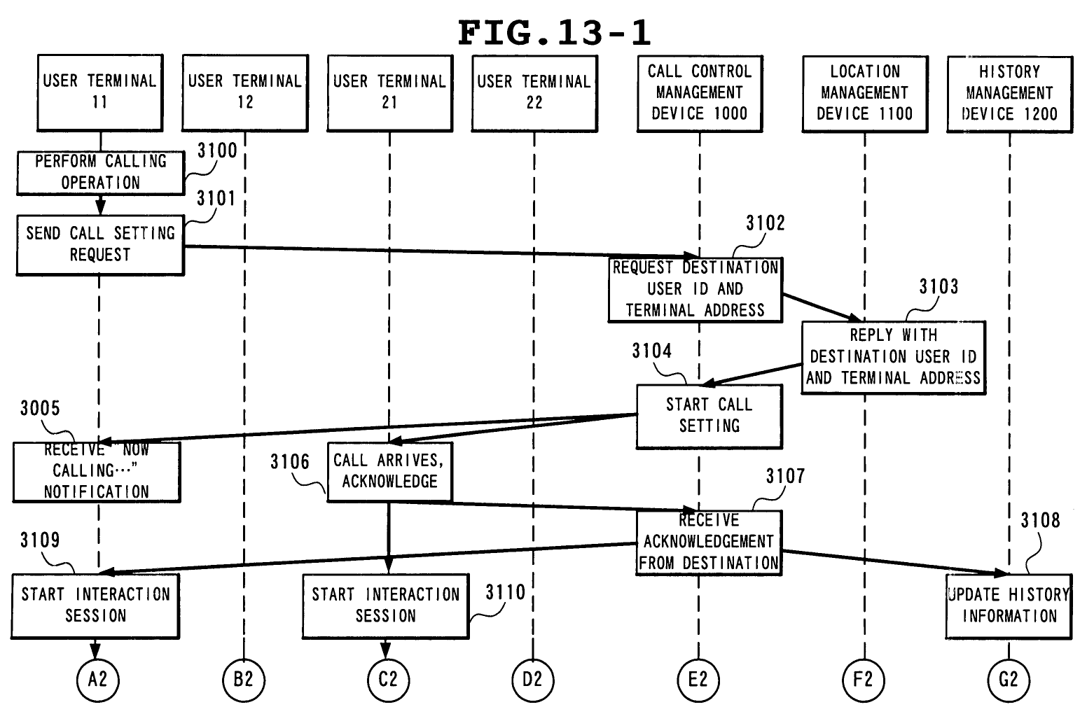

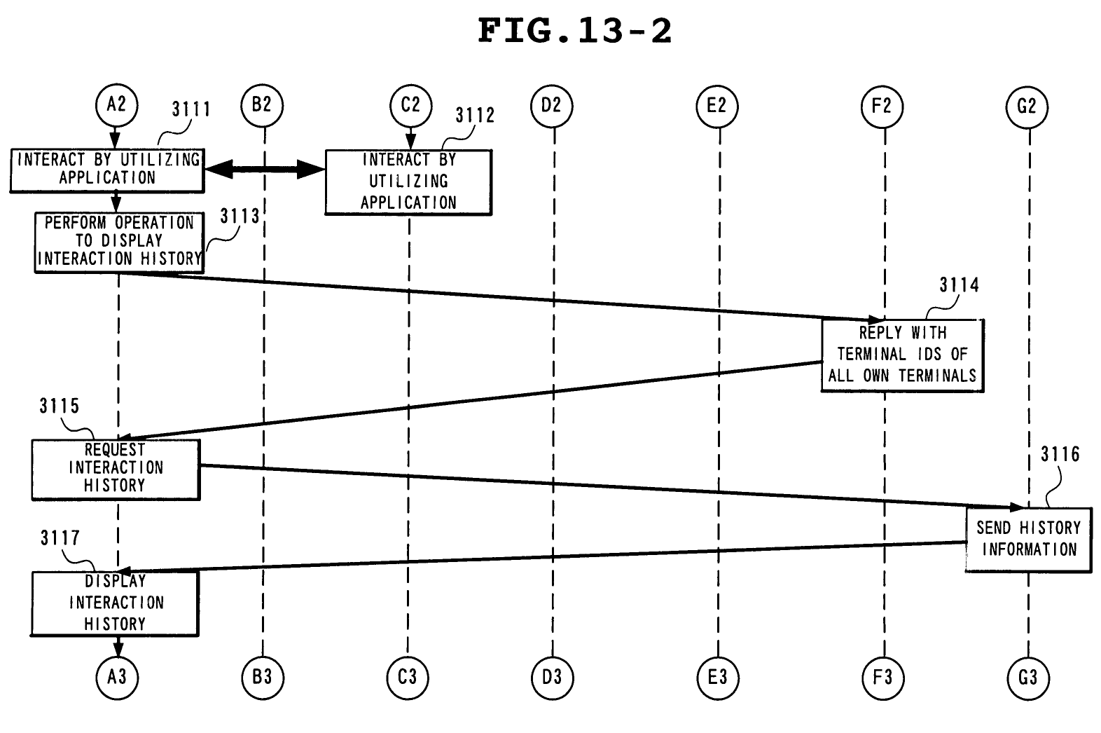

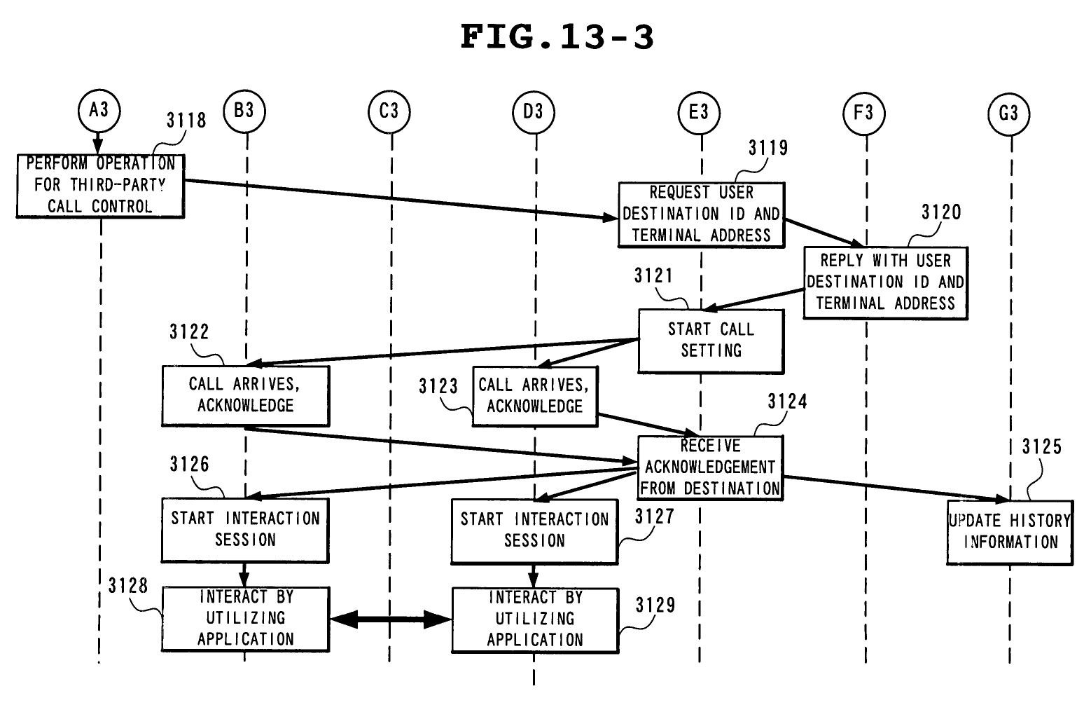

FIG. 12 is a flow chart illustrating the “normal call control” phase during which an interaction session is performed between the user terminal 12 of User A and the user terminal 22 of User B. FIG. 13 is a flow chart illustrating the “third-party call control” phase during which, after normal call control for an interaction session between the user terminal 11 of User A and the user terminal 21 of User B, an interaction session is performed between the user terminal 12 of User A and the user terminal 22 of User B by calling these terminals by the third-party call control through an operation from the user terminal 11 of User A. To avoid complications and ensure easier understanding, user terminals subsequent to a user terminal 13, user terminals subsequent to a user terminal 23 and user terminals subsequent to a user terminal N1 are omitted from the description below. Furthermore, while each user terminal typically stores other terminal IDs in its terminal setting information storage unit in order to enable the user to make calls to the other user terminals, the user terminal 11 of User A in this embodiment is assumed to hold only one other terminal ID, i.e., the terminal ID 2401 of the user terminal 21 of User B.

(Description of Normal Call Control)

With reference to FIG. 12, the “normal call control” phase will first be described. During this phase, the user terminal 22 of User B is called through an operation of the user terminal 12 of User A, and then an interaction session is performed between the user terminal 12 and the user terminal 22.

Step 3000:

This step takes place on the user terminal 12. User A operates the input device 12-2 to display on the display device 12-4 a list of other terminal IDs 2406 from the terminal setting information table 210 stored in the terminal setting information storage unit 12-6, as well as a list of APIDs 2510 and AP names 2511, which are included in the available AP list 2500 from the AP setting information table 213 stored in the AP setting information storage unit 12-7. User A then operates the input device 12-2 to select an other terminal ID 2406 that matches the terminal ID of the user terminal 22 of User B and a desired AP name 2511. By this, a process is initiated of requesting the user terminal 22 of User B to set a call, as described below.

Step 3001:

This step 3001 takes place on the user terminal 12 of User A. The communication data processing device 12-1 references the call control management device address 2403 from the terminal setting information table 210 stored in the terminal setting information storage unit 12-6. Using this information, the communication data processing device 12-1 connects to the call control management device 1000, and issues a call setting request by sending the user ID 2400, terminal ID 2401 and terminal address 2402 of User A from the terminal setting information table 210, together with the other terminal ID 2406 and APID 2510 of the user terminal 22 of User B, which have been selected in the step above, and the AP name 2511 corresponding to this APID 2510.

Step 3002:

This step takes place on the call control management device 1000. The call transfer device 1002 receives the user ID 2400, terminal ID 2401 and terminal address 2402 of User A and the other terminal ID 2406, APID 2510 and AP name 2511 of the user terminal 22 of User B, all of which have been sent from the user terminal 12. Using this information, the call transfer device 1002 connects to the location management device 1100, and sends the other terminal ID 2406 in relation to the user terminal 22 of User B to request the user ID of User B and the terminal address of the user terminal 22 corresponding thereto.

Step 3003:

This step takes place on the location management device 1100. The user information management device 1101 receives the other terminal ID 2406 in relation to the user terminal 22 of User B sent from the call transfer device 1002. The user information management device 1101 then searches the user information table 201 held in the user information storage unit 1102 to find a terminal ID 2101 which matches the received other terminal ID 2406, and sends the user ID 2100 corresponding to this terminal ID 2101, i.e., the user ID of User B, to the call control management device 1000. In addition, the terminal information management device 1103 receives the other terminal ID 2406 in relation to the user terminal 22 of User B sent from the call transfer device 1002. The terminal information management device 1103 then searches the terminal information table 204 held in the terminal information storage unit 1104 to find a terminal ID 2200 which matches this terminal ID, and sends the terminal address 2201 corresponding to this terminal ID 2200, i.e., the terminal address of the user terminal 22, to the call control management device 1000.

Step 3004:

This step takes place on the call control management device 1000. The call transfer device 1002 receives the user ID 2100 of User B and the terminal address 2201 of the user terminal 22 sent from the location management device 1100, and initiates a call setting process. More specifically, the call transfer device 1002 connects to the user terminal 22 of User B identified by this terminal address 2201, and sends the user ID of User A, the terminal ID and terminal address of the user terminal 12 and the APID, all of which have already been received from the source user terminal 12 of User A, to cause a call arrival process to take place. At the same time, the call transfer device 1002 connects to the source user terminal 12 of User A, and sends the user ID of User B received from the location management device 1100 to notify that it is now calling the user terminal 22.

Step 3005:

This step takes place on the user terminal 12 of User A. When the communication data processing device 12-1 receives the user ID and call notification of User B sent from the call transfer device 1002, the AP processing device 12-3 activates the application corresponding to the APID selected when the call setting request was initiated. A calling process is then performed. This process varies depending on the type of application activated. For example, a calling tone may be sounded, or a message reading “Now calling . . . ” may be displayed.

Step 3006:

This step takes place on the user terminal 22 of User B. When the communication data processing device 22-1 receives the user ID of User A, the terminal ID and terminal address of the user terminal 12 and the APID, all of which have been sent from the call transfer device 1002, the application corresponding to this APID is activated by the AP processing device 22-3 and a call arrival process is performed. This process varies depending on the type of application activated. For example, an incoming tone may be sounded, or a message reading “A call is arriving . . . ” may be displayed. When the user operates the input device 22-2 in response to the call arrival process, the communication data processing device 22-1 references the call control management device address 2403 from the terminal setting information table 210 held in the terminal setting information storage unit 22-6, and connects to the call control management device 1000 to notify that the incoming call has been acknowledged.

Step 3007:

This step takes place on the call control management device. On receiving from the user terminal 22 of User B an acknowledgement of the incoming call, the call transfer device 1002 connects to the source user terminal 12 of User A and notifies that the user terminal 22 has acknowledged the incoming call. At the same time, the call transfer device 1002 creates a new interaction session ID 2000 to uniquely identify this particular interaction session between the user terminal 12 and the user terminal 22, and records the created ID in the interaction session information table 200 held in the interaction session information storage device 1003. The call transfer device 1002 then acquires the current time, and connects to the history management device 1200 to transmit the created interaction session ID, the current time, the user ID of User A and the terminal ID of the user terminal 12 as the source-side information, the user ID of User B and the terminal ID of the user terminal 22 as the destination-side information, and the APID and AP name of the application used for the interaction session, all for the purpose of recording a history for this interaction session.

Step 3008:

This step takes place on the history management device 1200. When the history information management device 1201 receives the current time, the user ID of User A and the terminal ID of the user terminal 12 as the source-side information, the user ID of User B and the terminal ID of the user terminal 22 as the destination-side information, and the APID and AP name of the application used for the interaction session, all of which have been sent from the call transfer device 1002, the history information management device 1201 first records the history information concerning the source user terminal 12. More specifically, the history information management device 1201 searches the history information table 206 held in the history information storage device 1203 to find a terminal ID 2300 which matches the terminal ID of the user terminal 12 of User A on the source side, and creates on the interaction history list 2301 corresponding to this terminal ID 2300 a new set of interaction history data 2310. Information is stored in this set of interaction history data 2310, as follows. The items of interaction session ID 2320 and start time 2321 store the received interaction session ID and the received time, respectively. The item of send-and-receive type 2323 stores “outgoing,” the item of other-party user ID 2324 stores the user ID of User B, and the item of other-party terminal ID stores the terminal ID of the user terminal 22. The items of used APID 2326 and used AP name 2327 store the received APID and AP name, respectively.

Following this, the history information management device 1201 records the history information concerning the destination-side user terminal 22, as follows. The history information management device 1201 searches the history information table 206 held in the history information storage device 1203 to find a terminal ID 2300 which matches the terminal ID of the user terminal 22 of User B on the destination side, and creates on the interaction history list 2301 corresponding to this terminal ID 2300 a new set of interaction history data 2310. Information is stored in this set of interaction history data 2310, as follows. The items of interaction session ID 2320 and start time 2321 store the received interaction session ID and the received time, respectively. The item of send-and-receive type 2323 stores “incoming,” the item of other-party user ID 2324 stores the user ID of User A, and the item of other-party terminal ID stores the terminal ID of the user terminal 12. The items of used APID 2326 and used AP name 2327 store the received APID and AP name, respectively.

This updates the history information. At this point in time, the rest of the items in the updated history content table 208, i.e., end time 2322, skin ID 2328, loudness level 2329 and used content list 2330, contain a NULL value, respectively.

Steps 3009, 3010, 3011 and 3012:

These steps take place on the user terminal 12 of User A and the user terminal 22 of User B. An interaction session is started, making it possible for these users to interact using an application.

When the screen layout of such application is modified on either of the user terminal 12 or the user terminal 22 through an operation of the input device of such terminal, the skin ID corresponding to the screen layout after modification is stored in the skin ID 2512 in the available AP table 214 corresponding to the application, which is held in the AP setting information storage unit of that user terminal.

When the loudness level of such application is modified on either of the user terminal 12 or the user terminal 22 through an operation of the input device of such terminal, the loudness level after modification is stored in the loudness level 2513 in the available AP table 214 corresponding to the application, which is held in the AP setting information storage unit of that user terminal.

When a content ID 2600 is selected on either of the user terminal 12 or the user terminal 22 through an operation of the input device of such terminal, the content ID 2600 and the content name 2601 and content data 2602 corresponding thereto are sent to the other user terminal and stored in the content storage device of the other user terminal. As a result, the content data 2602 is displayed on the display devices of both the user terminals. More than one content may be used in one interaction session. The content ID and content name of the content used in this interaction session by this application are recorded in the used content list 2514 in the available AP table 214 corresponding to the application, which is held in the AP setting information storage unit.

Step 3013:

This step takes place on the user terminal 12. When User A performs an operation to end the interaction session from the input device 12-2, the communication data processing device 12-2 connects to the user terminal 22 of User B and sends a request to end the interaction session.

Step 3014:

This step takes place on the user terminal 12 of User A. When the interaction session is ended, the history information processing device 12-5 acquires the time at which the interaction session was ended, connects to the history management device 1200 and, through this connection, sends the terminal ID of the user terminal 12, the interaction session ID of this interaction session, the end time, the skin ID and loudness level which were being used by the application at the end of the interaction session and the content ID and content name of the content which was used in the interaction session. If more than one content was used in the interaction session, then the content IDs and content names of all the contents are sent.

Step 3015:

This step takes place on the history management device 1200. When the history information management device 1201 receives the terminal ID, the interaction session ID, the end time of the interaction session, the skin ID, the loudness level, and the content ID and content name of the content used in the interaction session, all of which have been sent from the user terminal 12 of User A, the history information table 206 held in the history information storage device 1203 is searched to find a terminal ID 2300 which matches the terminal ID of the user terminal 12. Then, from the interaction history data 2310 on the interaction history list 2301 corresponding to this terminal ID 2300, interaction history data 2310 which has an interaction session ID 2320 matching the received interaction session ID is found, and the received session end time, skin ID, loudness level, content ID and content name are stored in the items of end time 2322, skin ID 2328, loudness level 2329 and used content list 2330, which comprise the found set of interaction history data 2310 in the history content table 208.

Step 3016:

This step takes place on the user terminal 22 of User B. When the interaction session is ended, the history information processing device 22-5 acquires the current time, connects to the history management device 1200 and, through this connection, sends the terminal ID of the user terminal 22, the interaction session ID of this interaction session, the end time, the skin ID and loudness level which were being used by the application at the end of the interaction session and the content ID and content name of the content which was used in the interaction session. If more than one content was used in the interaction session, then the content IDs and content names of all the contents are sent.

Step 3017:

This step takes place on the history management device 1200. When the history information management device 1201 receives the terminal ID, the interaction session ID, the end time of the interaction session, the skin ID, the loudness level, the content ID and content name of the content used in the interaction session, all of which have been sent from the user terminal 22 of User B, the history information table 206 held in the history information storage device 1203 is searched to find a terminal ID 2300 which matches the terminal ID of the user terminal 22. Then, from the interaction history data 2310 on the interaction history list 2301 corresponding to this terminal ID 2300, interaction history data 2310 which has an interaction session ID 2320 matching the received interaction session ID is found, and the received session end time, skin ID, loudness level, content ID and content name are stored in the items of end time 2322, skin ID 2328, loudness level 2329 and used content list 2330, which comprise the found interaction history data 2310 in the history content table 208.

(Description of Third-Party Call Control)

Next, the “third-party call control” phase will be described with reference to FIG. 13. During this phase, the user terminal 21 of User B is called through an operation of the user terminal 11 of User A, followed by an interaction session between the user terminal 11 and the user terminal 21. During this interaction session, the user terminal 12 and the user terminal 22 are called through an operation of the user terminal 11, and then an interaction session is performed between the user terminal 12 and the user terminal 22. The descriptions of the steps that take place from when a calling operation is made by the user terminal 11 (step 3100) to when an interaction session between the user terminal 11 and the user terminal 21 is started and it becomes possible for the users to interact with each other by utilizing an application (step 3112) are omitted because they are the same as steps 3000 to 3012 in FIG. 12, which have been described in the section of the “normal call control” phase above. Hereafter, the subsequent steps will be described. In step 3108, with the start of an interaction session between the user terminal 11 of User A and the user terminal 21 of User B, the history information concerning the started interaction session is stored in the history information storage device 1203 of the history management device 1200.

Step 3113:

This step takes place on the user terminal 11. If, during an interaction session with the user terminal 21 of User B, User A performs on the user terminal 11 an operation required for displaying an interaction history through use of the input device 11-2, the history information processing device 11-5 first references the location management device address 2404 in the terminal setting information table 210 stored in the terminal setting information storage unit 11-6. Using the information, the history information processing device 11-5 connects to the location management device 1100, and through this connection, sends a terminal ID request which contains the user ID 2400 from the terminal setting information table 210, the user ID of User A set in the terminal ID 2401 and the terminal ID of the user terminal 11 to request a reply with the terminal IDs of all the user terminals owned by User A.

Step 3114:

This step takes place on the location management device 1100. The user information management device 1101 receives the user ID of User A and the terminal ID of the user terminal 11 contained in the terminal ID request sent from the user terminal 11, and searches the user information table 201 held in the user information storage unit 1102 to determine whether or not a user ID 2100 matching the received user ID exists. If such user ID exists, the user information management device 1101 further examines if any of all the terminal IDs 2101 corresponding to that user ID 2100 matches the terminal ID contained in the terminal ID request. If a user ID 2100 matching the received user ID does exist and if any of the terminal IDs corresponding to that user ID 2100 matches the terminal ID contained in the terminal ID request, the user information management device 1101 determines that the terminal ID request is a request from a legal user, and sends all the terminal IDs of the user terminals corresponding to the user ID, i.e., all the terminal IDs of the user terminals owned by User A, to the user terminal 11. On the other hand, if a user ID 2100 matching the received user ID does not exist, or if such a user ID exists but none of the terminal IDs corresponding to that user ID 2100 matches the terminal ID contained in the terminal ID request, then the user information management device 1101 sends to the requestor user terminal 11 a notification indicating that the terminal ID request is rejected.

Step 3115:

This step takes place on the user terminal 11. On receiving a plurality of terminal IDs sent from the user information management device 1101, the history information processing device 11-5 references the history management device address 2405 in the terminal setting information table 210 stored in the terminal setting information storage unit 11-6 and, using this information, connects to the history management device 1200. Through this connection, the history information processing device 11-5 sends the user ID of the user terminal 11 (i.e., the user ID of User A), the received plurality of terminal IDs, the current interaction session ID, the user ID of the user terminal 21, which is a party to the current interaction session (i.e., the user ID of User B; this ID has already been received from the call control management device 1000 by the communication data processing device 11-1 in steps 3104 and 3105 during the “normal call control” phase, in which a call for the first interaction session is set), to request a reply with an interaction history.

(Operation on Interaction History)

Step 3116:

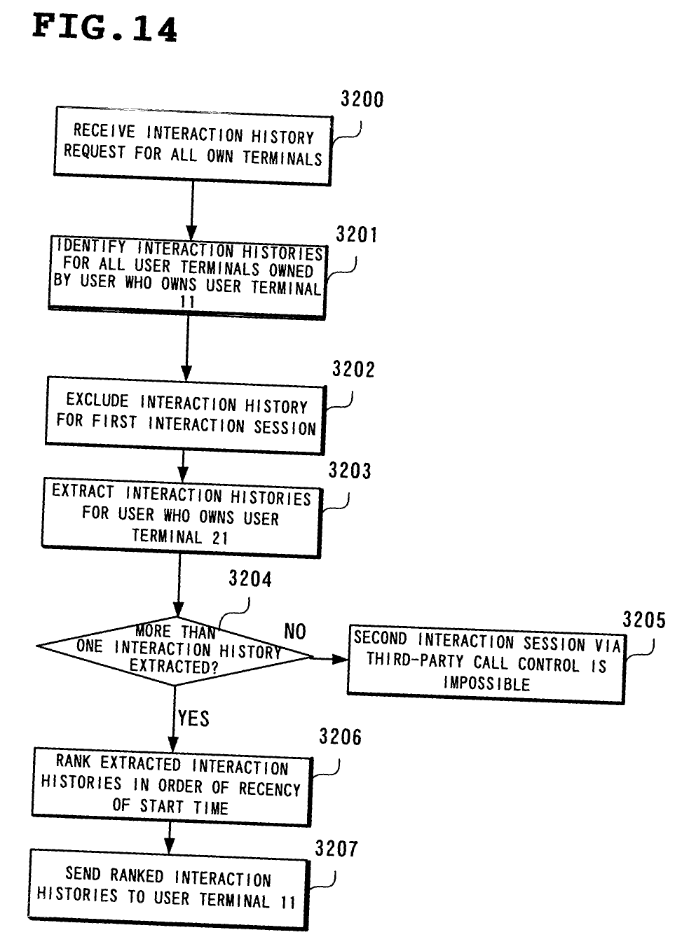

The process flow that takes place in the history management device 1200 in this step 3116 will be described with reference to FIG. 14.

Step 3200:

In the history management device 1200, the history information computation device 1202 first receives the user ID of User A, the plurality of terminal IDs, the interaction session ID and the user ID of the current other-party user terminal 21 (i.e., the user ID of User B) sent from the user terminal 11.

Step 3201:

Then, the history information computation device 1202 searches the history information table 206 held in the history information storage device 1203 to find all the terminal IDs 2300 which match the received plurality of terminal IDs in relation to User A. The interaction history lists 2301 showing these plurality of terminal IDs 2300 thus found represent the interaction histories for all the user terminals owned by User A, who owns the user terminal 11.

Step 3202:

Following this, from the interaction history list 2301 corresponding to the found terminals ID 2300, the history information computation device 1202 finds one interaction history whose interaction session ID 2320 in the history content table 208 matches the received interaction session ID (there should be only one such history because this is the interaction history for the first interaction session currently being performed), and excludes this interaction history data 2310 from the results of the search.

Step 3203:

From the rest of the interaction history data 2310, the history information computation device 1202 extracts only those histories whose other-party user ID 2324 in the history content table 208 match the user ID of User B, who owns the user terminal 21.

Step 3204:

Next, the history information computation device 1202 determines whether or not more than one interaction history data 2310 has been extracted in step 3203. If yes, the history information computation device 1202 proceeds to step 3206; if no, it proceeds to step 3205.

Step 3205:

Reaching this step means that the first interaction session is the initial interaction session between User A, the owner of the user terminal 11, and User B, the owner of the user terminal 21, and that no information to other user terminals owned by User B who owns the user terminal 21 has been detected from the interaction histories for all the user terminals owned by User A who owns the user terminal 11. Therefore, the history information computation device 1202 sends a notification indicating that it is impossible to start the second interaction session via third-party call control, and ends the current process.

Step 3206:

Next, the history information computation device 1202 ranks the sets of interaction history data 2310 extracted in step 3203 in the order of recency of start time 2321.

Step 3207:

The history information computation device 1202 then sends the ranked plurality sets of interaction history data 2310 to the user terminal 11.

Step 3117:

In the user terminal 11, the history information processing device 11-5 receives the ranked data items in the interaction history data 2310 sent from the history information computation device 1202, and the display device 11-4 displays them. At this point in time, the interaction history data for the interaction session between the user terminal 12 and the user terminal 22 performed during the “normal call control” phase, described above with reference to FIG. 12, is displayed at the highest rank position because it is the most recent interaction history data. The interaction history data displayed at the highest rank position contains the terminal ID of the user terminal 22 as the other-party terminal ID. As described above, the other terminal IDs held by the user terminal 11 of User A in the terminal setting information storage unit 11-6 is the terminal ID of User B's user terminal 21 only and none other. In other words, according to the prior arts, the terminal ID that the user terminal 11 can acquire is limited to the terminal ID of the user terminal 21. According to this embodiment, however, the terminal IDs of User A's user terminal 12 and User B's user terminal 22 can also be obtained by referencing the terminal IDs and interaction history data that are being displayed.

Thus, according to this embodiment, when the second interaction session is about to be started after the first interaction session has been started, the user terminal 11 owned by User A can share the interaction histories for the other user terminal 12 and so on owned by User A. It is, therefore, possible to acquire the address information concerning both the user terminal 12 and so on owned by User A and the user terminal 22 and so on owned by User B. This means that the second interaction session can be started via third-party call control through an operation of the user terminal 11 owned by User A, as described below.

Step 3118:

This step takes place on the user terminal 11. When User A selects through the input device 11-2 a certain set of interaction history data between the user terminal 12 of User A and the user terminal 22 of User B from the ranked interaction history data which are being displayed on the display device 11-4 and performs operations for third-party call control, the communication data processing device 11-1 references the call control management device address 2403 from the terminal setting information table 210 stored in the terminal setting information storage unit 12-6 and connects to the call control management device 1000. Through this connection, the communication data processing device 11-1 issues a request to make settings for third-party call control by sending the information contained in the selected interaction history data items, i.e., the terminal ID of the user terminal 12, the terminal ID of the user terminal 22, the APID used in the interaction session between these terminals, the skin ID, the loudness level and the used content list.

Step 3119:

This step takes place on the call control management device 1000. On receiving the third-party call control setting request sent from the user terminal 11, the call transfer device 1002 connects to the location management device 1100 and, through this connection, sends the terminal ID of User A's user terminal 12 and the terminal ID of User B's user terminal 22 to request the information corresponding thereto, i.e., the user ID of User A, the terminal address of the user terminal 12, the user ID of User B and the terminal address of the user terminal 22.

Step 3120:

This step takes place on the location management device 1100. On receiving the terminal ID of User A's user terminal 12 sent from the call transfer device 1002, the user information management device 1101 searches the user information table 201 held in the user information storage unit 1102 to find a terminal ID 2101 which matches the received terminal ID of the user terminal 12 and sends the user ID 2100 corresponding to the found terminal ID 2101, i.e., the user ID of User A, to the call control management device 1000. Similarly, on receiving the terminal ID of User B's user terminal 22 sent from the call transfer device 1002, the user information management device 1101 searches the user information table 201 held in the user information storage unit 1102 to find a terminal ID 2101 which matches the received terminal ID of the user terminal 22 and sends the user ID 2100 corresponding to the found terminal ID 2101, i.e., the user ID of User B, to the call control management device 1000.

In addition, on receiving the terminal ID of User A's user terminal 12 sent from the call transfer device 1002, the terminal information management device 1103 searches the terminal information table 204 held in the terminal information storage unit 1104 to find a terminal ID 2200 which matches this terminal ID, and sends the terminal address 2201 corresponding to this terminal ID 2200, i.e., the terminal address of the user terminal 12, to the call control management device 1000. Similarly, on receiving the terminal ID of User B's user terminal 22 sent from the call transfer device 1002, the terminal information management device 1103 searches the terminal information table 204 held in the terminal information storage unit 1104 to find a terminal ID 2200 which matches this terminal ID, and sends the terminal address 2201 corresponding to this terminal ID 2200, i.e., the terminal address of the user terminal 22, to the call control management device 1000.

Step 3121:

This step takes place on the call control management device 1000. The call transfer device 1002 receives the user IDs of Users A and B and the terminal addresses of the user terminal 12 and 22 sent from the location management device 1100, and initiates a call setting process. More specifically, the call transfer device 1002 connects to the user terminal 12 of User A, and sends the user ID of User B, the terminal ID and terminal address of the user terminal 22, used APID, the skin ID, the loudness level and the used content list to cause a call arrival process to be initiated. At the same time, the call transfer device 1002 connects to the user terminal 22 of User B, and sends the user ID of User A, the terminal ID and terminal address of the user terminal 12, the used APID, the skin ID, the loudness level and the used content list to cause a call arrival process to be initiated.

Step 3122:

This step takes place on the user terminal 12 of User A. When the communication data processing device 11-1 receives the user ID of User B, the terminal ID and terminal address of the user terminal 22 and the APID, the skin ID, the loudness level and the used content list, all of which have been sent from the call transfer device 1002, the application corresponding to the received APID is activated by the AP processing device 11-3 and a call arrival operation is performed. This process varies depending on the type of application activated. For example, an incoming tone may be sounded, or a message reading “A call is arriving . . . ” may be displayed. When the user operates the input device 11-2 in response to this call arrival operation, the communication data processing device 11-1 references the call control management device address 2403 from the terminal setting information table 210 held in the terminal setting information storage unit 11-6, and connects to the call control management device 1000 to notify that the incoming call has been acknowledged. The skin ID, the loudness level and the used content list are passed to the application as activation parameters. The application displays the screen layout corresponding to that skin ID, enables voices to be regenerated at the loudness level corresponding to that loudness level, and displays the content corresponding to the content ID indicated on that used content list.

Step 3123:

This step takes place on the user terminal 22 of User B. When the communication data processing device 22-1 receives the user ID of User A, the terminal ID and terminal address of the user terminal 12, the APID, the skin ID, the loudness level and the used content list, all of which have been sent from the call transfer device 1002, the application corresponding to the received APID is activated by the AP processing device 22-3 and a call arrival operation is performed. This process varies depending on the type of application activated. For example, an incoming tone may be sounded, or a message reading “A call is arriving . . . ” may be displayed. When the user operates the input device 22-2 in response to this call arrival operation, the communication data processing device 22-1 references the call control management device address 2403 from the terminal setting information table 210 held in the terminal setting information storage unit 22-6, and connects to the call control management device 1000 to notify that the incoming call has been acknowledged. The skin ID, the loudness level and the used content list are passed to the application as activation parameters. The application displays the screen layout corresponding to that skin ID, enables voices to be regenerated at the loudness level corresponding to that loudness level, and displays the content corresponding to the content ID indicated on that used content list.

Step 3124:

This step takes place on the call control management device 1000. If the call transfer device 1002 receives notifications of acknowledgement of the incoming call from both of the user terminal 12 of User A and the user terminal 22 of User B, respectively, the call transfer device 1002 creates a new interaction session ID 2000 to uniquely identify the interaction session between the user terminal 12 and the user terminal 22 and records the interaction session ID 2000 in the interaction session information table 200 held in the interaction session information storage device 1003. The call transfer device 1002 then acquires the current time, and connects to the history management device 1200 to transmit the created interaction session ID, the current time, the user ID of User A, who is one of the parties subjected to third-party call control, and the terminal ID of the user terminal 12, the user ID of User B, who is the other of the parties subjected to third-party call control, and the terminal ID of the user terminal 22, and the APID and AP name of the application used for the interaction session, all for the purpose of recording in a history for this interaction session.

Step 3125:

This step takes place on the history management device 1200. When the history information management device 1201 receives the current time, the user ID of User A, who is one of the parties subjected to third-party call control, and the terminal ID of the user terminal 12, the user ID of User B, who is the other of the parties subjected to third-party call control, the terminal ID of the user terminal 22, and the APID and AP name of the application used for the interaction session, all of which have been sent from the call transfer device 1002, the history information management device 1201 first records the history information concerning the first-mentioned user terminal 12. More specifically, the history information management device 1201 searches the history information table 206 held in the history information storage device 1203 to find a terminal ID 2300 which matches the terminal ID of the user terminal 12 of User A, and creates on the interaction history list 2301 corresponding to this terminal. ID 2300 a set of new interaction history data 2310. Information is stored in this interaction history data 2310, as follows. The items of interaction session ID 2320 and start time 2321 store the received interaction session ID and the received time, respectively. The item of send-and-receive type 2323 stores “third-party call control,” the item of other-party user ID 2324 stores the user ID of User B, and the item of other-party terminal ID stores the terminal ID of the user terminal 22. The items of used APID 2326 and used AP name 2327 store the received APID and AP name, respectively.

Following this, the history information management device 1201 records the history information concerning the other user terminal 22, as follows. The history information management device 1201 searches the history information table 206 held in the history information storage device 1203 to find a terminal ID 2300 which matches the terminal ID of the user terminal 22 of User B on the destination side, and creates in the interaction history list 2301 corresponding to this terminal ID 2300 a new set of interaction history data 2310. Information is stored in this interaction history data 2310, as follows. The items of interaction session ID 2320 and start time 2321 store the received interaction session ID and the received time, respectively. The item of send-and-receive type 2323 stores “third-party call control,” the item of other-party user ID 2324 stores the user ID of User A, and the item of other-party terminal ID stores the terminal ID of the user terminal 12. The items of used APID 2326 and used AP name 2327 store the received APID and AP name, respectively.

This updates the history information. At this point in time, the rest of the updated history content table 208, i.e., end time 2321, skin ID 2328, loudness level 2329 and used content list 2330, contain a NULL value, respectively.

Steps 3126, 3127, 3128 and 3129:

These steps take place on the user terminal 12 of User A and the user terminal 22 of User B. An interaction session is started, making it possible for these terminals to interact with each other using an application. The skin ID, the loudness level and the content list have already been passed to the application by the activation parameters. The application displays the screen layout corresponding to that skin ID, controls the loudness level according to that loudness level, and displays the content corresponding to the content ID indicated on that used content list. Therefore, no further operations for these parameters are needed unless they have been modified.

Therefore, according to this embodiment, when User A attempts to start the second interaction session after starting the first interaction session, the terminal 11 owned by User A can share the interaction histories for the other terminals 12 and so on owned by User A, allowing User A to reference the content IDs of the contents used in the past and contained in these interaction histories. This means that, at the start of the second interaction session, User A can designate which content to use in the second interaction session among the contents stored in the terminal 12 owned by User A, in advance from the terminal 11 owned by User A.

In addition, according to this embodiment, the task becomes easier of designating a content to be used in the second interaction session from the contents stored in the terminal 12 owned by User A, because User A can designate the content ID of any of the contents used in the past simply by designating any interaction history in another terminal 12 owned by User A. The necessity is thus eliminated for User A to go through the cumbersome effort to operate the terminal 12 owned by User A in order to search for a content to send to the other-party user from a list of the contents stored in the terminal 12 owned by User A.

Furthermore, according to this embodiment, User A is not required to perform the cumbersome task of checking if the application settings, such as screen layout and loudness level, are as preferred by User A every time the second interaction session is started and, if not, of changing the settings according to his or her preference. Instead, this embodiment allows User A to designate a particular skin ID or loudness level from those used in the past simply by designating an interaction history in another terminal 12 owned by User A. This makes it possible for User A to switch the screen layout and/or loudness level of the application to be used in the second interaction session to another, as appropriate according to with whom User A is interacting.

Next, the effects of the first embodiment will be described.

The first effect is that, when User A attempts to start the second interaction session after the first interaction session has been started, a terminal a1 owned by User A can acquire the address information concerning a terminal a2 owned by User A and a terminal b2 owned by User B and, moreover the second interaction session via third-party call control can be started by an operation from the terminal a1 owned by User A.

The reason for this is as follows. An interaction history for each user terminal is accumulated in the history management device, and the address information concerning the user terminals which have participated in interaction sessions is stored in such interaction history. User terminals owned by a user can thus share the interaction histories for the other user terminals owned by this user via a history management device, so that these user terminals can acquire the address information stored in these interaction histories.

The second effect is that any of the contents stored in a terminal a2 owned by User A, which will be used in the second interaction session, can be designated from a terminal a1 owned by User A in advance at the start of the second interaction session.

This is because a user terminal owned by a user can share interaction histories for other user terminals owned by the user via a history management device and thus can reference the information of any of the contents stored in the interaction histories, as well as because the user can start the second interaction session after designating a content in advance.

The third effect is that the task becomes easier of designating a content stored in a terminal a2 owned by User A, which will be used in the second interaction session.

The reason for this is the same as that for the second effect.

The fourth effect is that application setting information, such as the screen layout and/or loudness level of the application to be used in the second interaction session, can be switched as appropriate according to with whom a user is interacting.

The reason for this is as follows. A user terminal owned by a user can share the interaction histories for other user terminals owned by the user via a history management device and thus can acquire the interaction history specific to the other party to a particular interaction session. This allows the user to start the second interaction session by reusing the application setting information stored in the interaction history, such as the skin ID, which defines the screen layout of the used application, and the loudness level.

The first embodiment will now be described based on a practical example.

Three users are assumed: Alice, Bob and Carol. Alice has a user ID of “ALICE” and owns user terminals 11 and 12. Bob has a user ID of “BOB” and owns user terminals 21, 22, 23. Carol has a user ID of “CAROL” and owns a user terminal 31. The terminal types and terminal IDs of these user terminals are as follows.

User terminal 11: IP phone terminal, alice1@foo

User terminal 12: PC terminal, alice2@foo

User terminal 21: cell phone terminal, bob1@foo

User terminal 22: PC terminal, bob2@bar

User terminal 23: PC terminal, bob3@qux

User terminal 31: PC terminal, carol1@baz

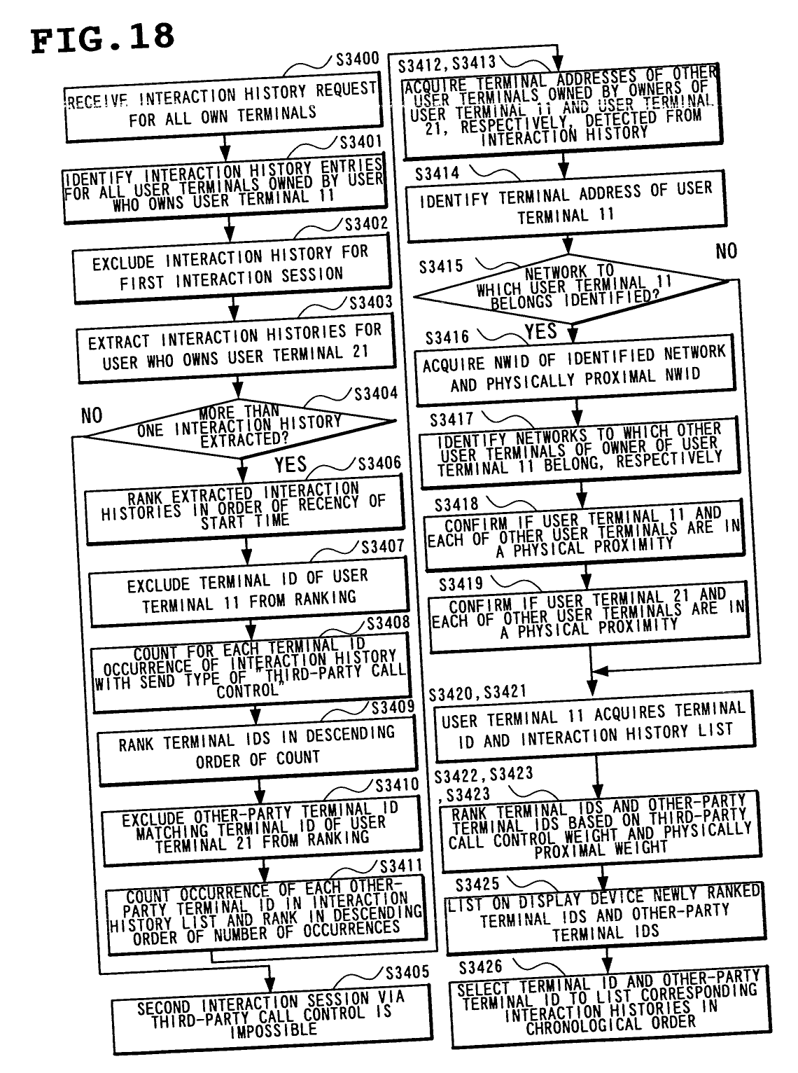

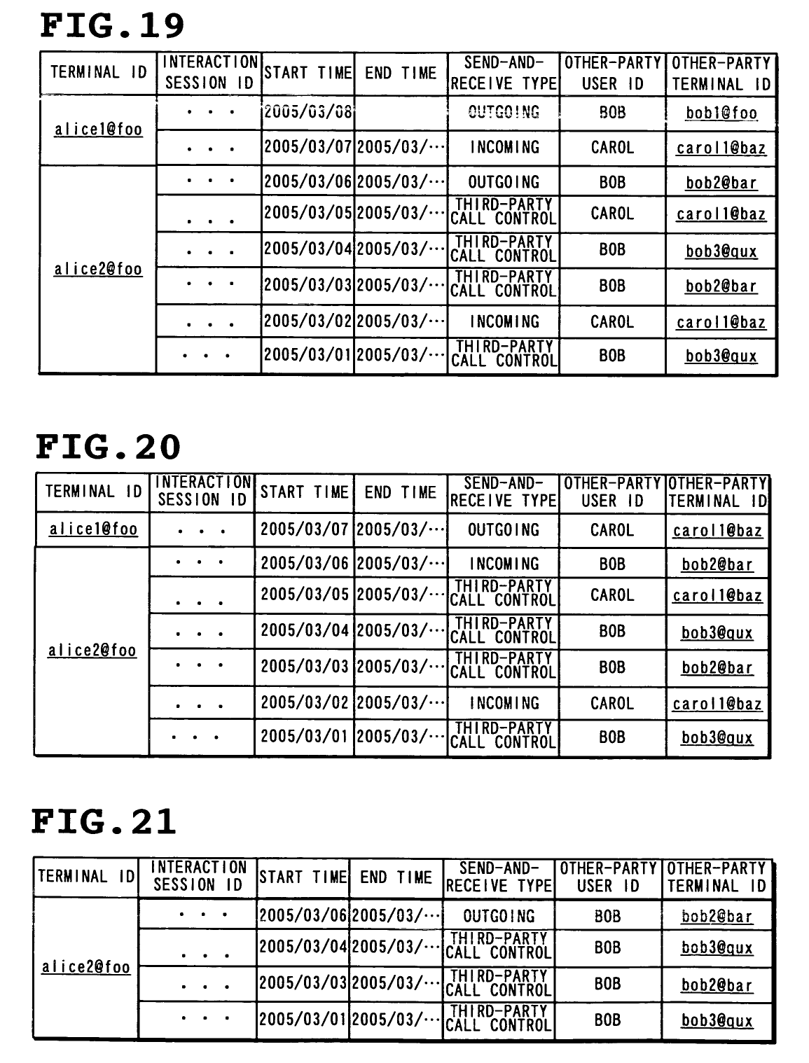

There are four networks installed, with NW IDs of “foo,” “bar,” “baz” and “qux,” respectively. The character string in a terminal ID following @ corresponds to each of these NW IDs on a one-to-one basis. Although “foo” and “bar” logically represent two different networks, they are installed in the physically same location. Several interaction sessions have already been performed by these users, and FIG. 19 shows an interaction history list for the user terminals owned by Alice, which is one of the interaction history lists stored in the intersection history information management device 1203.

In this context, if Alice operates the user terminal 11 to display an interaction history in step 3113 in FIG. 13 during an interaction session with the user terminal 21 of Bob, the processes as described below will take place.

First, the history information processing device 11-5 in the user terminal 11 connects to the location management device 1100, and sends the user ID of the user terminal 11 to request a reply with the terminal IDs of all the user terminals owned by Alice (step 3113). The user information management device 1101 in the location management device 1100 receives the user ID of Alice sent from the user terminal 11, and sends to the user terminal 11 alice1@foo and alice2@foo to notify the terminal IDs of all the user terminals owned by Alice (step 3114).

The history information processing device 11-5 in the user terminal 11 connects to the history management device 1200, and sends the user ID “ALICE” of the user terminal 11, the terminal IDs of alice1@foo and alice2@foo received from the user information management device 1101, the current interaction session ID and the user ID “BOB” of the user terminal 21, which is the current other-party terminal to the current interaction session, thereby requesting a reply with the appropriate interaction history (step 3115).

On receiving the user ID “ALICE” of Alice, the terminal IDs of alice1@foo and alice2@foo, the interaction session ID and the user ID “BOB” of the current other-party user terminal 21, all of which have been sent from the user terminal 11 (step 3200), the history information computation device 1202 in the history management device 1200 searches the history information table 206 held in the history information storage device 1203 to find all the terminal IDs which match the received plurality of terminal IDs of Alice. The history information computation device 1202 then further finds an interaction history list which corresponds to the found plurality of terminal IDs (step 3201). FIG. 19 shows this interaction history list thus found. Next, the history information computation device 1202 finds an interaction session with an interaction session ID which matches the received interaction session ID, and excludes the interaction history data for the found interaction session from the results of the search. The resultant interaction history data is as shown in FIG. 20.

From the interaction history data shown in FIG. 20, the history information computation device 1202 extracts only histories for interactions with the other-party user ID “BOB.” The resultant interaction history data is as shown in FIG. 21.

The history information computation device 1202 then ranks the interaction history data sets in FIG. 21 according to the recency of start time, and sends the ranked interaction history data sets to the user terminal 11.

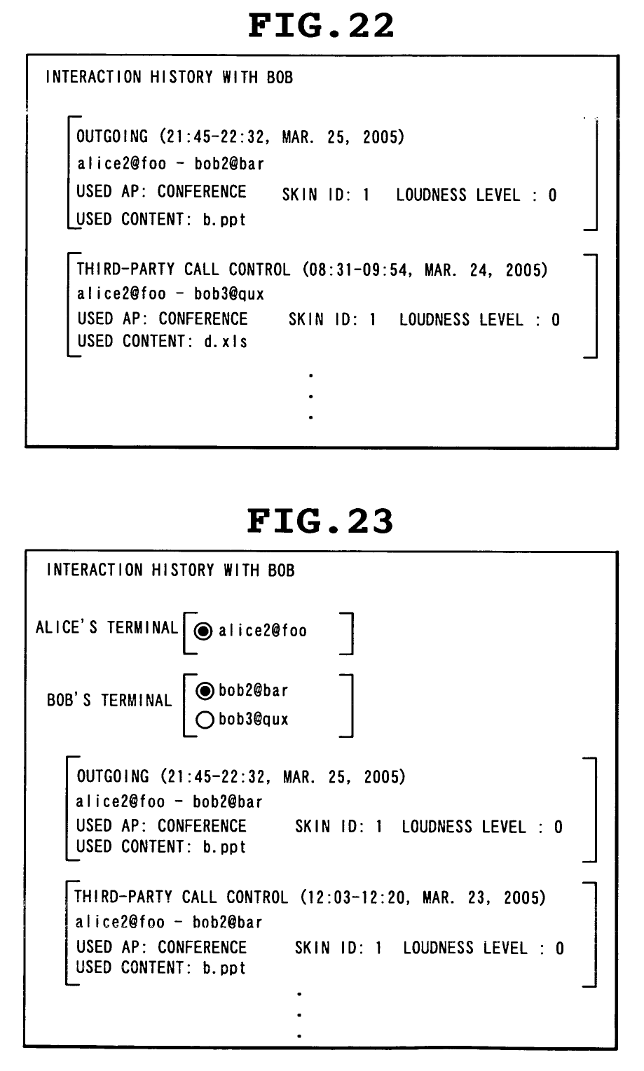

The history information processing device 11-5 in the user terminal 11 receives the ranked data sets in the interaction history data 2310 sent from the history information computation device 1202 and displays these ranked data sets on the display device 11-4 as shown in the example of FIG. 22. Since Alice is currently performing an interaction session with Bob, the information titled “Interaction history with Bob” appears, which lists the interaction history information between the user terminal 12, a user terminal of Alice other than the user terminal 11, and the user terminals owned by Bob in a chronological order. By performing on the user terminal 11 an operation to select one of the listed intersection histories and then performing an operation to start third-party call control (this operation varies depending on the functions of the user terminal being used. For example, in the case of an IP telephone terminal and a cell phone terminal, this operation means pressing a hardware-based button specially provided to initiate third-party call control. In the case of a PC terminal, this operation means clicking on a button displayed on the screen for this purpose), Alice can start an interaction session between her user terminal and Bob's user terminal described in the selected interaction history.

### Second Embodiment

An embodiment according to the second aspect of the present invention will now be described in detail by referring to the drawings.

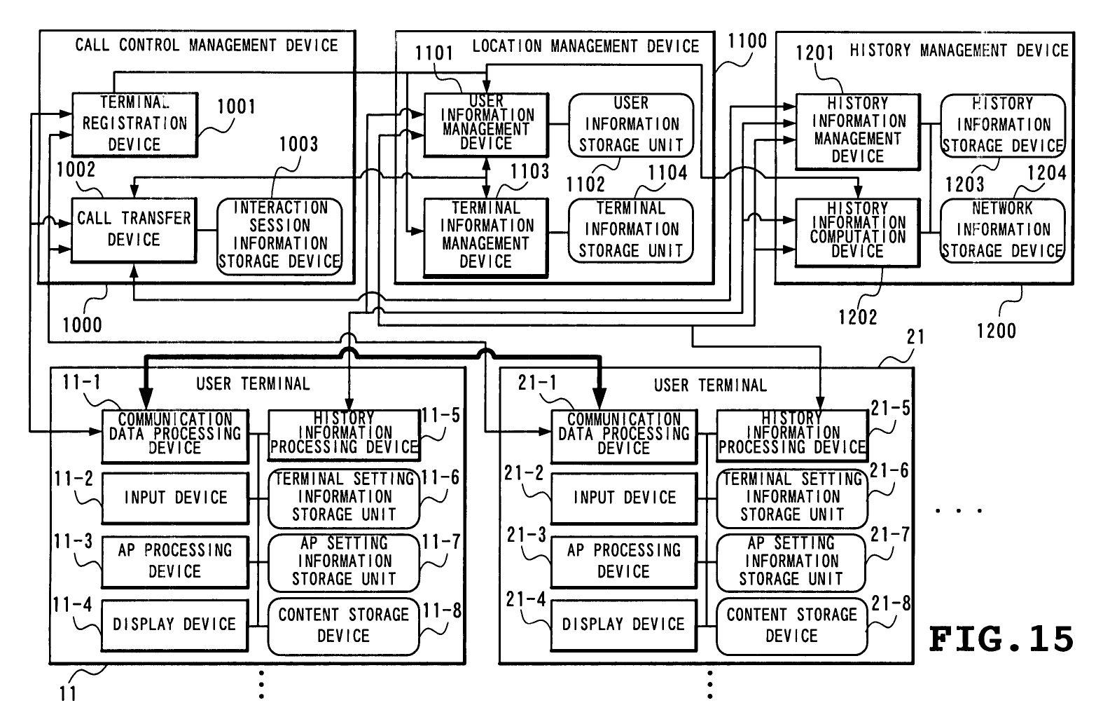

With reference to FIG. 15, a communication system according to the second embodiment of the present invention differs from the first embodiment in two points. The first difference is that the history management device 1200 is added a network information storage device 1204, which caters to the needs that may arise when a plurality of logical networks are installed by managing the overlapping of physical locations of these networks. The second difference is that the history information computation device 1202 ranks interaction history data sets from the perspective of the physical installation locations of networks.

The term “logical network” used herein may mean a network using a LAN or leased line, a VPN-based network such as a wide area Ethernet (registered trademark), an IP-VPN, an Internet VPN or other similar network.

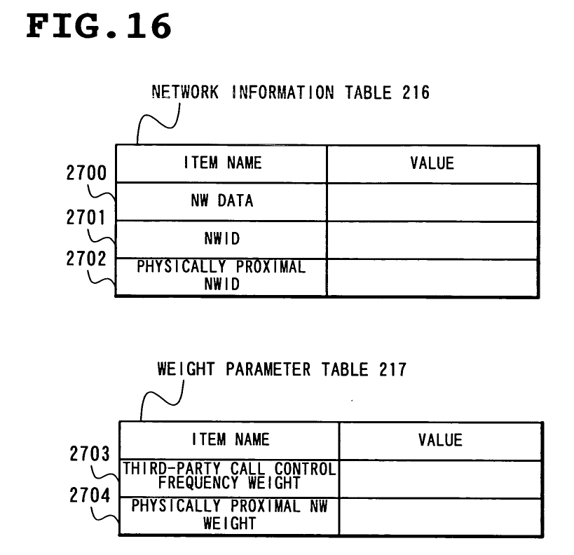

The network information storage device 1204 stores a plurality of network information tables 216 as shown in FIG. 16 and one weight parameter table 217, also shown in FIG. 16.

Each network information table 216 stores one each of NW data 2700, NWID 2701 and physically proximal NWID 2702. The NW data 2700 is used to indicate the logical size of a network. For example, the NW data 2700 can comprise a network address and a subnet mask, which indicate that this network has a network address of “192.168.0.*” and the subnet mask has a logical size of “255.255.255.0.” The NWID 2701 is used to identify the NW data 2700. The physically proximal NWID 2702 stores, among other logical networks, the NWID of a network whose physical installation location overlaps that of the network which is identified as NWID 2701 in the network information table 216. We assume here that the NWID 2701 of one logical network A is “A” and the NWID 2701 of another logical network B is “B.” If the physical installation locations of these two logical networks overlap with each other, “B” is stored in the physically proximal NWID 2702 for the network A, and “A” in the physically proximal NWID 2702 for the network B.

The weight parameter table 217 stores one each of third-party call control frequency weight 2703 and physically proximal NW weight 2704. The third-party call control frequency weight 2703 and the physically proximal NW weight 2704 are used during the below-described process of raking interaction histories.

The operation of this embodiment will now be described in detail.

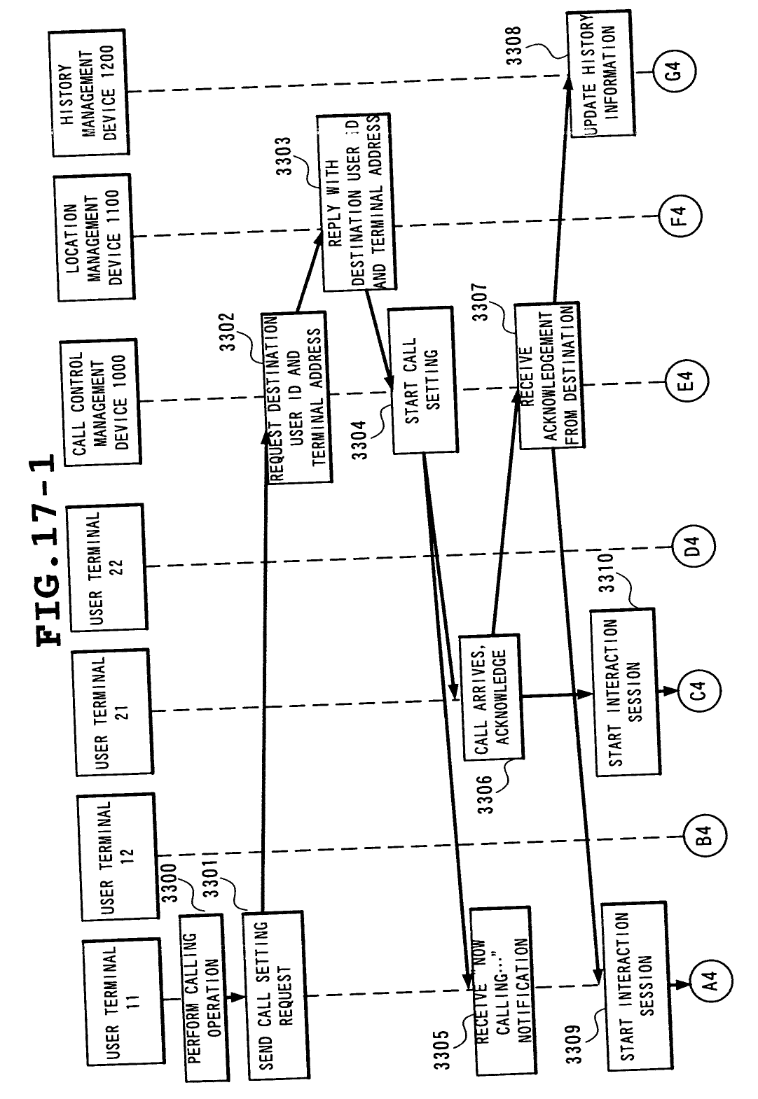

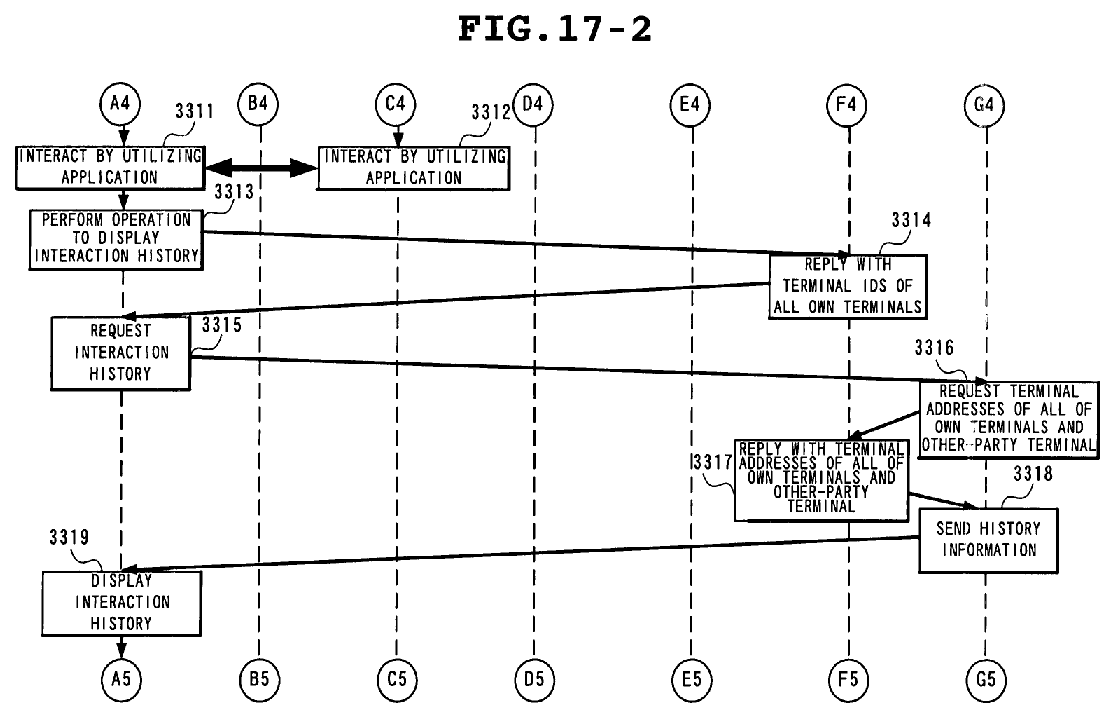

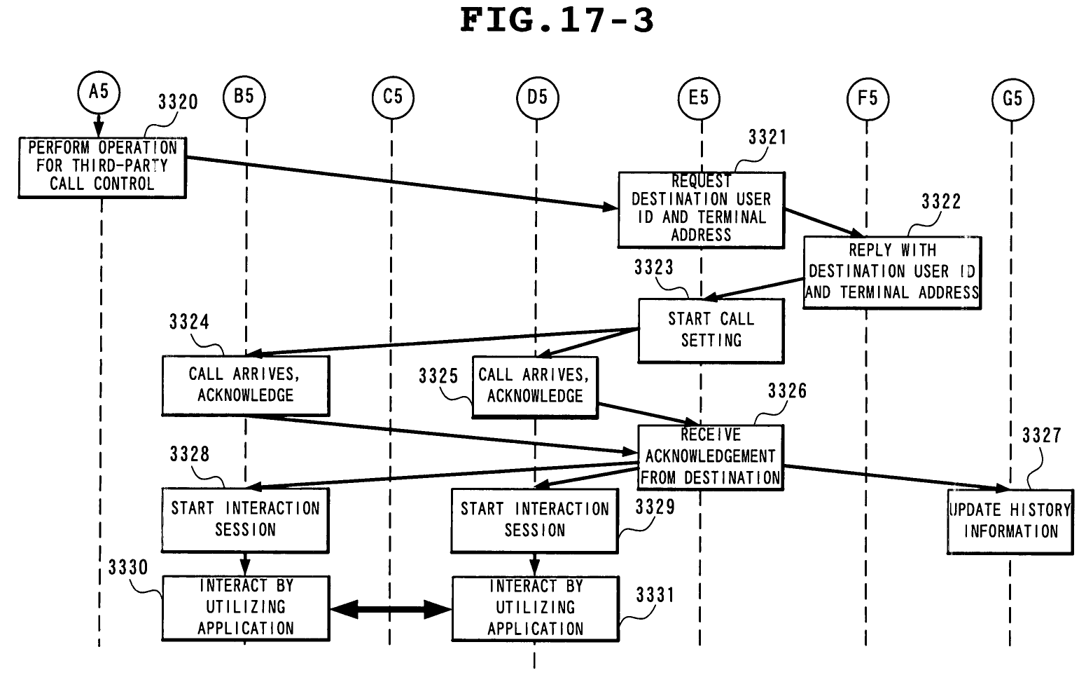

FIG. 17 is a flow chart illustrating the “third-party call control” phase, during which normal call control is first performed for an interaction session between the user terminal 11 of User A and the user terminal 21 of User B, and then, by an operation from the user terminal 11 of User A, the user terminal 12 of User A and the user terminal 22 of User B are called via third-party call control to initiate another interaction session. FIG. 17 differs from FIG. 13 of the first embodiment in steps 3316 to 3319. Steps 3300 to 3312 and steps 3320 to 3331 are the same as the corresponding steps, i.e., steps 3100 to 3112 and steps 3118 to 3129, respectively, in FIG. 13 of the first embodiment. For confirmation, in steps 3300 to 3312, an interaction session between a user terminal 11 and a user terminal 21 is initiated by a calling operation from the user terminal 11, and it is made possible for users to interact with each other by utilizing an application. In steps 3320 to 3331, another interaction session is initiated between a user terminal 12 and a user terminal 22 via third-party call control and the subsequent processes are performed. Descriptions of steps 3316 to 3319 will now be given below.

Steps 3316 to 3319:

The process flow that takes place in these steps on the history management device 1200 will be described with reference to FIG. 18.

Steps 3400 to 3406:

These steps are approximately the same as steps 3200 to 3206 in FIG. 14 of the first embodiment. More specifically, the history information computation device 1202 first receives the user ID of User A, the plurality of terminal IDs, the interaction session ID and the user ID of the current other-party user terminal 21 (i.e., the user ID of User B), all of which have been sent from the user terminal 11 (step 3400). The history information computation device 1202 then searches the history information table 206 held in the history information storage device 1203 to find an interaction history list corresponding to the received plurality of terminal IDs in relation to User A (step 3401), and excludes the interaction history for the first interaction session from the interaction history lists corresponding to the found terminal IDs (step 3402). At this time, in preparation for the process in step 3410 to be performed later, the history information computation device 1202 acquires and saves the ID of the current other-party user terminal 21 from the interaction history for the first interaction session. The method of acquiring the ID of the current other-party user terminal 21 is not limited to this one. For example, the ID of the current other-party user terminal 21 may be sent from the user terminal 11 to the history information computation device 1202, together with the above-listed information. The history information computation device 1202 then extracts, from the rest of the interaction history data, only those sets of interaction history data that correspond to the user ID of User B (step 3403) of the first interaction session, and ranks the extracted sets of interaction history data in the order of recency of start time (step 3406).

Step 3407:

Next, the history information computation device 1202 searches the sets of interaction history data associated with the respective user terminals of User A, which have been ranked in the order of recency of start time, to find a set of interaction history data which matches the terminal ID of the user terminal 11, which is a user terminal being used by User A in the first interaction session. The interaction history data corresponding to this terminal ID is excluded from the subjects of the ranking.

Step 3408:

The history information computation device 1202 references the sets of interaction history data which have remained from the process in step 3407, and, for each of the terminal IDs of User A, counts the number of those sets of interaction history data of interaction sessions all of whose send-and-receive type is “third-party call control.”

Step 3409:

The history information computation device 1202 ranks the terminal IDs of User A counted in step 3408 in the descending order of the number of interaction sessions via third-party call control. The highest-ranked user terminal represents a user terminal called via third-party call control most frequently of all the user terminals owned by User A (excluding the user terminal 11).

Step 3410:

The history information computation device 1202 references interaction history data for each of the terminal IDs of User A after the process in step 3409. First, for the purpose of performing a ranking on the other-party terminal IDs (i.e., all the user terminals owned by User B) stored in each set of interaction history data, the history information computation device 1202 finds from all the other-party terminal IDs a terminal ID matching the terminal ID of the user terminal 21, which has been used in the first interaction session, and excludes the found terminal ID from the subjects of the ranking.

Step 3411:

The history information computation device 1202 then, for each of the terminal IDs of User A after the process in step 3409, counts the number of occurrences in the interaction history data of other-party terminal IDs to interaction sessions via third-party call control, and ranks these other-party terminal IDs in the descending order of the number of occurrences. The highest-rank user terminal represents a user terminal which is owned by User B and which has been called most frequently of all the user terminals that have experienced in the past at least one interaction session with a user terminal of User A by third-party call control (excluding the user terminal 21).

Step 3412:

The history information computation device 1202 connects to the location management device 1100 and requests terminal addresses corresponding to the found plurality of terminal IDs of User A and terminal addresses respectively corresponding to all of the terminal IDs of User B stored in the found plurality of interaction history lists.

Step 3317:

The terminal information management device 1103 in the location management device 1100 replies with the terminal addresses corresponding to the terminal IDs of User A and the terminal addresses corresponding to the terminal IDs of User B, both of which have been received from the history information computation device 1202.

Step 3318 can be broken down into several sub-steps (steps 3413 to 3420), as follows.

Step 3413:

The history information computation device 1202 in the history management device 1200 receives the terminal addresses corresponding to the terminal IDs of User A and the terminal addresses corresponding to the terminal IDs of User B, from the location management device 1100.

Step 3414:

The history information computation device 1202 finds the terminal address of the user terminal 11 from the received terminal addresses.

Step 3415:

The history information computation device 1202 finds a logical network which includes the terminal address of the user terminal 11 from the logical networks corresponding to the NW data 2700 stored in the network information storage device 1204. In the example described above, the terminal address of the user terminal 11 is first expressed as a binary number. A logical multiplication is performed on this binary number and a binary number representing the subnet address of each of the NW data 2700. Whether or not the terminal address of the user terminal 11 is included in the network address of the NW data 2700 can be determined by checking if the result of this calculation matches the network address of the NW data 2700. If it is determined that the terminal address of the user terminal 11 is included in the NW data 2700, the history information computation device 1202 proceeds to step 3416. Otherwise, it proceeds to step 3420.

Step 3416:

The history information computation device 1202 finds a NWID 2701 and a physically proximal NWID 2702 corresponding to the found NW data 2700. These results represent the ID of the logical network to which the user terminal 11 of User A belongs and the ID of the other logical network which is located in a physical proximity to this logical network.

Step 3417:

The history information computation device 1202 searches the plurality of terminal IDs of User A received from the location management device 1100 to find all the terminal IDs other than the one which matches the terminal ID of the user terminal 11. Based on the results, the history information computation device 1202 determines the NWIDs 2701 of the logical networks which respectively include these terminal IDs.

Step 3418:

The history information computation device 1202 checks whether or not each of the determined NWIDs 2701 matches either of the previously-determined NWID 2700 corresponding to the user terminal 11 or the physically proximal NWID 2702 corresponding to the user terminal 11. If it does, the terminal ID corresponding to the NWIDs 2701 is marked. This marked user terminal of User A is a user terminal which is owned by User A and which is most likely to be located in a physical proximity to the user terminal 11.

Step 3419:

The history information computation device 1202 performs a similar marking process on the terminal IDs 2324 of the user terminals of User B received from the location management device 1100. More specifically, among the user terminals of User B other than the user terminal 21, a user terminal which is most likely to be located in a physical proximity to the user terminal 21 is marked.

Step 3420:

The history information computation device 1202 then sends the interaction history data for each of the ranked (or ranked and marked) user terminal IDs of User A, together with the third-party call control device weights 2703 and physically proximal weights 2704 stored in the weight parameter table 217, to the user terminal 11.

Step 3319 can be broken down into several sub-steps (steps 3421 to 3426), as follows.

Step 3421:

The history information processing device 11-5 in the user terminal 11 receives the interaction history data for each of the ranked (or ranked and marked) user terminal IDs of User A, together with the third-party call control frequency weights 2703 and physically proximal NW weights 2704 stored in the weight parameter table 217.

Step 3422:

The history information processing device 11-5 obtains a value for each of the received plurality of terminal IDs of User A by multiplying the reciprocal of the rank by the third-party call control frequency weight 2703. For the marked terminal ID, it further adds to the resultant value a value obtained by dividing the physically proximal NW weight 2704 by the number of the terminal IDs. For example, we assume that User A, who owns the user terminal 11, has ten user terminals. One of these user terminals is assigned a rank of “2” and also marked. The value of the third-party call control device weight 2703 is “3,” and the value of the physically proximal weight 2704 is “5.” In this case, we obtain a value of “2.0” from a calculation: (third-party call control device weight/rank of terminal)+(physically proximal weight/total number of terminals)=(3/2)+(5/10)=1.5+0.5=2.0.

Step 3423:

The history information processing device 11-5 re-ranks the terminal IDs of User A in the descending order of this value.

Step 3424:

The history information processing device 11-5 performs a similar calculation to re-rank the ranked (or ranked and marked) plurality of other-party terminal IDs of User B received previously.

Step 3425:

The display device 11-4 displays a list of the newly ranked terminal IDs of User A and a list of the newly ranked terminal IDs of User B for each terminal ID of User A.

Step 3426:

Using the input device 11-2, the user selects one terminal ID from the list of the terminal IDs of User A displayed on the display device 11-4. Similarly, the user selects one terminal ID from the list of the terminal IDs of User B displayed on the display device 11-4. Then, a list of the interaction history data concerning the interaction sessions performed in the past between the user terminal identified by the selected terminal ID of User A and the user terminal identified by the selected terminal ID of User B is displayed in the order of recency of start time. Following this, when the user selects by using the input device 11-2 one of the interaction history data displayed on the display device 11-4 (for example the interaction history data concerning interaction sessions between the user terminal 12 and the user terminal 22), and performs an operation to initiate third-party call control, the user terminal 12 and the user terminal 22 are called and an interaction session is initiated between the user terminal 12 and the user terminal 22.

The following effects can be achieved by the second embodiment, in addition to the effects of the first embodiment.

According to the second embodiment, when an attempt is made to initiate the second interaction session after the first interaction session has been started, interaction histories for a user terminal 11 owned by User A and other user terminal owned by User A can be shared even if User A and User B own a large number of terminals, respectively. Since the terminals owned by User A and User B can be ranked in the descending order of frequency of being used in the second interaction session, the plurality of terminals owned by User A and User B can be listed in the descending order of frequency of being used in the second interaction session even if some of these terminals have experienced the second interaction session many times.

In addition, according to the second embodiment, when an attempt is made to initiate the second interaction session after the first interaction session has been started, a user terminal 11 owned by User A can share the interaction histories for the other user terminals owned by User A, even if these terminals belong to a plurality of different logical networks. Since a user terminal in a physical proximity to the user terminal 11 owned by User A can easily be distinguished from the other user terminals owned by User A that are not in a physical proximity to the user terminal 11 and, similarly, a user terminal in a physical proximity to the user terminal 21 owned by User B can be distinguished from the other user terminals owned by User B that are not in a physical proximity to the user terminal 21, by considering to which logical network each terminal belongs and if each terminal is installed in a physical proximity to a logical network, it can easily be determined whether or not a user terminal 11 owned by User A and a user terminal 12 owned by User A are in a physical proximity to each other and whether or not a user terminal 21 owned by User B and other user terminal 22 owned by User B are in a physical proximity to each other.

Moreover, according to the second embodiment, when performing a ranking of terminal IDs of User A and a ranking of terminal IDs of User B, it is possible to adjust the influence over the rankings according to the frequency of being called via third-party call control as well as according to physical proximity between user terminals, by increasing or decreasing the value of the third-party call control frequency weight 2703 and the value of the physically proximal NW weight 2704.

The second embodiment will now be described based on a practical example.

We assume here that a practical example is similar to the practical example of the second embodiment. The steps in FIG. 18 up to step 3406 are the same as the first embodiment and yield the results as shown in FIG. 21. The processes subsequent to this state will be described below.

Although step 3407 excludes the terminal ID of the user terminal 11 from the ranking results of FIG. 21, the results at this point in time for this practical example are the same as FIG. 21, because the terminal ID of the user terminal 11 is already absent from FIG. 21.

Step 3408 counts the number of the occurrences of third-party call control for the terminal ID of alice2@foo to be “3,” and step 3409 ranks the terminal ID in the descending order of this count in step 3409, but the results for this practical example are the same as FIG. 21 because this figure contains only one terminal ID (alice2@foo).

Furthermore, steps 3410 and 3411 count the number of occurrences of terminal ID in the interaction history data for bob2@bar and bob3@qux, respectively, yielding a count of twice for both the terminal IDs. Both the terminals are ranked in the first place. Therefore, here again, the results are the same as the FIG. 21.

In steps 3412 to 3419, it has been determined that terminal alice1@foo and terminal alice2@foo belong to a network called “foo” and that the terminal alice1@foo and the terminal alice2@foo are likely to be in a physical proximity to each other. The terminal alice2@foo is marked. It has also been determined that the terminals bob1@foo, bob2@bar and bob3@qux belong to networks called “foo,” “bar” and “qux,” respectively, and that the terminal bob1@foo and the terminal bob2@bar are likely to be in a physical proximity to each other. The terminal bob2@bar is marked.

In steps 3420 to 3422, assuming that the values of the third-party call control device weight 2703 and the physically proximal weight 2704 are “3” and “5,” respectively, the value obtained from the calculation, (third-party call control device weight/rank of terminal)+(physically proximal weight/total number of terminals), is as follows:
Terminal alice2@foo: (3/1)+(5/2)=3.0+2.5=5.5

In step 3423, a ranking is performed on the results of the calculation. Since alice2@foo is the only terminal, this terminal is ranked the first.

In step 3424, the calculation, (third-party call control device weight/rank of terminal)+(physically proximal weight/total number of terminals), is performed for the other-party terminal. This yields the results as shown below and ranks the terminal bob2@bar in the first place and the terminal bob3@qux in the second place.
Terminal bob2@bar: (3/1)+(5/2)=3.0+2.5=5.5
Terminal bob3@qux: (3/1)+0=3.0

In step 3425, the list of terminal IDs of User A shows the terminal alice2@foo at the first rank. In the corresponding list of terminal IDs of User B, the terminal bob2@bar and the terminal bob3@qux appear at the first and second ranks, respectively. An example screen at this point in time is shown in FIG. 23.

With reference to FIG. 23, the section “ALICE's terminals” shows the user terminal alice2@foo only, because alice2@foo is the only user terminal owned by Alice other than the user terminal alice1@foo. On the other hand, Bob has two user terminals in addition to the user terminal bob1@foo: the user terminals bob2@bar and bob3@qux. Therefore, in the section of “BOB's terminals,” which corresponds to “ALICE's terminals” containing “alice2@foo” only, these two user terminals are shown. It should be noted that the user terminal bob2@bar is shown first, followed by the user terminal bob3@qux. In FIG. 19, the interaction history between the user terminal alice2@foo and the user terminal bob2@bar has only one entry having the send-and-receive type of “third-party call control,” while the interaction history between the user terminal alice2@foo and the user terminal bob3@qux has two histories with the send-and-receive type of “third-party call control.” If the number of times of third-party call control is the only consideration, then the section of “BOB's terminal” should show the user terminal bob3@qux first, followed by the user terminal bob2@bar below it. However, as described above, it is a known fact that the network to which the user terminal alice2@foo belongs is installed in the same location as the network to which the user terminal bob2@bar belongs, but not in the same location as the network to which the user terminal bob3@qux belongs. In this case, a weight is given to this physically proximal, resulting in the first appearance of the user terminal bob2@bar and then the user terminal bob3@qux below it. Below this section, limiting to between the user terminal alice2@foo and the user terminal bob2@bar, the historical information concerning the past interaction sessions is listed in a chronological order.

Although certain aspects and embodiments of the present invention have been described in the foregoing, the present invention is not limited to these but allows various other additions and modifications. The functions of a communication terminal (user terminal) and a history management device which constitute a communication system of the present invention may of course be realized using hardware, but can also be implemented through use of computers and programs. The program for a communication terminal is provided by being recorded on a computer-readable record medium, such as a magnetic disk and a semi-conductor memory, and makes a computer function as a communication terminal according to each of the aspects and embodiments described above by being read by the computer during a startup or other process and controlling the operation of the computer. The program for a history management device is provided by being recorded on a computer-readable record medium, such as a magnetic disk and a semi-conductor memory, and makes a computer function as a history management device according to each of the aspects and embodiments described above by being read by the computer during a startup or other process and controlling the operation of the computer.

### INDUSTRIAL APPLICABILITY

The present invention can be applied to various uses. For example, a user may at first be interacting with another using voice only by a telephone terminal, but as the interaction session progresses, may have difficulties to convey his or her intention by voice only. In such a situation, the present invention allows the user to switch to another interaction session using a PC or other terminal which can handle image and text in addition to voice and convey his or her intention using image, voice and text simultaneously.

While a user is remotely consulting with an operator at a help desk or contact center in a distant place by making a call using a telephone terminal, an explanatory material may be displayed by the operator on a PC or other terminal owned by the user.

During an interaction session between users by using the respective terminals, the operation or behavior of one of the terminals may become unstable, making it difficult for the users to continue the conversation comfortably. In this case, the user facing the problem may immediately switch to another terminal which he or she owns and proceed with the interaction session.

Finally, during an interaction session between users by using the respective terminals, one of the users may encounter a situation that forces him or her to move from the current location to another. This user can immediately switch to a terminal portable with the user, such as a cell phone, or to a terminal installed at the destination location, to resume the interaction session.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A communication system, comprising:
a plurality of communication terminals owned by a plurality of users, a call control management device which intermediates the establishment of an interaction session between said communication terminals and a history management device which manages interaction histories are connected with each other through a communication network, wherein
said history management device including a history information storage unit which accumulates an interaction history corresponding to the identifiers of said communication terminals for an interaction session between said communication terminals, which interaction history containing at least the identifier of the other-party user and the identifier of the other-party terminal; a history information management unit which registers in said history information storage unit said interaction history; and a history information computation unit which receives from said communication terminal an interaction history request containing the identifier of the other-party user with which an interaction session has been established and the identifiers of the other communication terminals owned by the owner of own communication terminal, retrieves, from said history information storage unit, the interaction history for each interaction session respectively corresponding to the identifiers of the other communication terminals specified in the interaction history request, each of which contains the other-party user identifier matching the other-party user identifier specified in the interaction history request, and sends the retrieved interaction history and the corresponding identifiers of said communication terminals to the requesting communication terminal; wherein
said communication terminal including a history information processing unit which, when an operation to display interaction history is performed by the user while an interaction session with another communication terminal is being performed, sends to said history information computation unit an interaction history request containing the identifier of the other-party user with which an interaction session has already been established and the identifiers of the other communication terminals owned by the owner of own communication terminal, and displays on a display unit the interaction history received from said history information computation unit, together with the identifiers of the corresponding communication terminals.

2. The communication system as set forth in claim 1, wherein
said history management device includes a network information storage unit which stores overlapping relationships among logical networks from the perspective of physical installation locations, and
said history information computation unit determines by referencing said network information storage unit a physical proximity between the logical network which includes said communication terminal currently performing an interaction session with said communication terminal which has sent said interaction history request belongs and the logical network which includes each of the communication terminals identified by the identifiers of the other-party terminals contained in said retrieved interaction histories, and sends the results of this determination to said requesting communication terminal.

3. The communication system as set forth in claim 1, further comprising
a location management device which is capable of communicating with said plurality of communication terminals, and
said location management device includes a user information storage unit which stores an association relationship between the identifier of the owner of said communication terminal and the identifier of said communication terminal, and a user information management unit which receives from said communication terminal a terminal identifier request containing the identifier of the owner of own communication terminal, retrieves from said user information storage unit the identifier of the communication terminal corresponding to the identifier of the owner contained in said terminal identifier request, and sends the retrieved identifier of the communication terminal to the requesting communication terminal.

4. The communication system as set forth in claim 1, wherein
said history management device includes a network information storage unit which stores overlapping relationships among logical networks from the perspective of physical installation locations, and
said history information computation unit determines by referencing said network information storage unit a physical proximity between the logical network which includes said communication terminal currently performing an interaction session with said communication terminal which has sent said interaction history request and the logical network which includes each of the communication terminals identified by the identifiers of the other-party terminals contained in said retrieved interaction histories, and sends the results of this determination to said requesting communication terminal,
a location management device which is capable of communicating with said plurality of communication terminals is provided, and
said location management device includes a user information storage unit which stores an association relationship between the identifier of the owner of said communication terminal and the identifier of said communication terminal, and a user information management unit which receives from said communication terminal a terminal identifier request containing the identifier of the owner of own communication terminal, retrieves from said user information storage unit the identifier of the communication terminal corresponding to the identifier of the owner contained in said terminal identifier request, and sends the retrieved identifier of the communication terminal to the requesting communication terminal.

5. The communication system as set forth in claim 1, wherein
said call control management device includes a call transfer unit which receives from said communication terminal a third-party call control setting request containing the identifiers of two communication terminals desiring to establish an interaction session and then establishes an interaction session between said two communication terminals identified by the identifiers contained in said third-party call control setting request, and
said communication terminal includes a communication data processing unit which sends to said call transfer unit a third-party call control setting request which contains, among the interaction histories displayed on said display unit and the corresponding identifiers of said communication terminals, the identifier of a communication terminal contained in the interaction history selected by the user and the identifier of said communication terminal corresponding to said selected interaction history.

6. The communication system as set forth in claim 1, wherein
said history management device includes a network information storage unit which stores overlapping relationships among logical networks from the perspective of physical installation locations, and
said history information computation unit determines by referencing said network information storage unit a physical proximity between the logical network which includes said communication terminal currently performing an interaction session with said communication terminal which has sent said interaction history request and the logical network which includes each of the communication terminals identified by the identifiers of the other-party terminals contained in said retrieved interaction histories, and sends the results of this determination to said requesting communication terminal,
said call control management device includes a call transfer unit which receives from said communication terminal a third-party call control setting request containing the identifiers of two communication terminals desiring to establish an interaction session and then establishes an interaction session between said two communication terminals identified by the identifiers contained in said third-party call control setting request, and
said communication terminal includes a communication data processing unit which sends to said call transfer unit a third-party call control setting request which contains, among the interaction histories displayed on said display unit and the corresponding identifiers of said communication terminals, the identifier of a communication terminal contained in the interaction history selected by the user and the identifier of said communication terminal corresponding to said selected interaction history.

7. The communication system as set forth in claim 5, wherein
each interaction history stored in said history information storage unit further contains the identifier of the application used in the interaction session and the identifier of the content used in the application,
said communication data processing unit sends to said call transfer unit the application identifier and content identifier contained in said selected interaction history by including in said third-party call control setting request,
said call transfer unit sends to said two communication terminals desiring to establish an interaction session the identifier of the application and the identifier of the content which are to be used in the interaction session, and
said communication terminal activates the application corresponding to said application identifier received from said call transfer unit, and is provided with an AP processing unit which displays on the display unit the content corresponding to said content identifier received from said call transfer unit.

8. The communication system as set forth in claim 5, wherein
said interaction history stored in said history information storage unit further contains the identifier of the application used in an interaction session and the setting information,
said communication data processing unit sends to said call transfer unit the identifier of the application contained in said selected interaction history and setting information by including in said third-party call control setting request,
said call transfer unit sends to said two communication terminals desiring to establish an interaction session the identifier of the application to be used in the interaction session and setting information, and
said communication terminal activates the application corresponding to said application identifier received from said call transfer unit, and is provided with an AP processing unit which notifies said application setting information received from said call transfer unit to said application as activation parameters.

9. The communication system as set forth in claim 8, wherein
said application setting information at least contains either of skin ID or loudness level.

10. The communication system as set forth in claim 5, wherein
each interaction history stored in said history information storage unit further contains a send-and-receive type which indicates whether or not the interaction session was performed via third-party call control,
said history information computation unit counts the occurrences of the send-and-receive type of third-party call control contained in said retrieved interaction histories for each identifier of said communication terminals corresponding to said retrieved interaction histories, and ranks the identifiers of said communication terminals corresponding to said retrieved interaction histories in the descending order of participation in interaction sessions via third-party call control.

11. A method of browsing interaction histories for a communication system wherein a plurality of communication terminals owned by a plurality of users, a call control management device which intermediates the establishment of an interaction session between said communication terminals and a history management device which manages interaction histories are connected with each other through a communication network, comprising the steps of:
the history information management unit in said history management device registering an interaction history for each interaction session performed by said communication terminal, which at least contains the identifier of the other-party user and the identifier of the other-party terminal, in association with the identifier of said communication terminal,
when an operation to display interaction histories is performed by the user while an interaction session with another communication terminal is being performed, said communication terminal sending to said history information computation unit in said history management device an interaction history request which contains the identifier of the other-party user with which an interaction session has been established and the identifiers of the other communication terminals owned by the owner of own communication terminal,
the history information computation unit in said history management device receiving said interaction history request from said communication terminal, searching from said history information storage unit the interaction histories for each interaction session respectively corresponding to the identifiers of the other communication terminals specified in the interaction history request to retrieve interaction histories, each of which contains the other-party user identifier matching the other-party user identifier specified in said interaction history request, and sending the retrieved interaction histories and the identifiers of communication terminals corresponding to the requesting communication terminal;
and said communication terminal displaying on a display unit the interaction histories received from said history information computation unit, together with the identifiers of the corresponding communication terminals.

12. A history management device, wherein
being connected with a plurality of communication terminals owned by a plurality of users through a communication network, and
including a history information storage unit which accumulates interaction histories corresponding to the identifiers of said communication terminals, each of these interaction histories being an interaction history for an interaction session between said communication terminals and at least containing the identifier of the other-party user and the identifier of the other-party terminal,
a history information management unit which registers in said history information storage unit an interaction history for each interaction session performed by said communication terminals, and
a history information computation unit which receives from said communication terminal an interaction history request containing the identifier of the other-party user with which an interaction session has been established and the identifiers of the other communication terminals owned by the owner of own communication terminal, retrieves, from said history information storage unit, the interaction history for each interaction session respectively corresponding to the identifiers of the other communication terminals specified in the interaction history request, each of which contains the other-party user identifier matching the other-party user identifier specified in the interaction history request, and sends the retrieved interaction history and the corresponding identifiers of said communication terminals to the requesting communication terminal.

13. The history management device as set forth in claim 12, wherein
a network information storage unit which stores overlapping relationships among logical networks from the perspective of physical installation locations is provided, and said history information computation unit determines by referencing said network information storage unit a physical proximity between the logical network which includes said communication terminal currently performing an interaction session with said communication terminal which has sent said interaction history request and the logical network which includes each of the communication terminals identified by the identifiers of the other-party terminals contained in said retrieved interaction histories, and sends the results of this determination to said requesting communication terminal.

14. A communication terminal, wherein
being connected with a history management device which manages interaction histories between a plurality of communication terminals through a communication network, and
including a history information processing unit which, when an operation to display interaction histories is performed by the user while an interaction session with another communication terminal is being performed, sends to said history management device an interaction history request containing the identifier of the other-party user with which an interaction session has already been established and the identifiers of the other communication terminals owned by the owner of own communication terminal, and, in response to said interaction history request, receives from said history management device, and displays on a display unit, the interaction histories and the identifiers of the corresponding communication terminals.

15. A communication terminal, wherein
being connected with a history management device which manages interaction histories between a plurality of communication terminals through a communication network, and
including a history information processing unit which, when an operation to display interaction histories is performed by the user while an interaction session with another communication terminal is being performed, sends to said history management device an interaction history request containing the identifier of the other-party user with which an interaction session has already been established and the identifiers of the other communication terminals owned by the owner of own communication terminal; in response to said interaction history request, receives from said history management device an interaction history and said corresponding communication terminal identifier, together with the results of determining a physical proximity between the logical network which includes said communication terminal with which own current terminal has established an interaction session and the logical network which includes the communication terminal identified by the identifier of the other-party terminal contained in said received interaction history; displays a list of the identifiers of the other-party terminals for each of the received identifiers of own communication terminals contained in each of the corresponding interaction histories, arranged in ascending order of distance to the other-party communication terminal which is currently performing an interaction session; and, when one of the own communication terminal identifiers displayed and one of the corresponding other-party communication terminal identifiers on the list are selected by the user, displays the interaction history between these two selected communication terminals.

16. A program running on a computer to serve as a history management device which is connected with a plurality of communication terminals owned by a plurality of users through a communication network and which has a history information storage unit to accumulate interaction histories corresponding to the identifiers of said communication terminals, each of these interaction histories being an interaction history for an interaction session between said communication terminals and at least containing the identifier of the other-party user and the identifier of the other-party terminal, comprising:
a history information management function which registers in said history information storage device an interaction history for each interaction session performed by said communication terminals, and
a history information computation function which receives from said communication terminal an interaction history request containing the identifier of the other-party user with which an interaction session is currently being performed and the identifiers of the other communication terminals owned by the owner of own communication terminal; searches, from said history information storage unit, the interaction histories for each interaction session respectively corresponding to the identifiers of the other communication terminals specified in the interaction history request to retrieve interaction histories, each of which contains the other-party user identifier matching the other-party user identifier specified in said interaction history request; and sends the retrieved interaction histories and the identifiers of corresponding communication terminals to the requesting communication terminal.

17. A program running on a computer to serve as a history management device which is connected with a plurality of communication terminals owned by a plurality of users through a communication network and which has a history information storage unit to accumulate interaction histories corresponding to the identifiers of said communication terminals, each of these interaction histories being an interaction history for an interaction session between said communication terminals and at least containing the identifier of the other-party user and the identifier of the other-party terminal, and a network information storage unit to store overlapping relationships among logical networks from the perspective of physical installation locations, comprising:
a history information management function which registers in said history information storage device an interaction history for each interaction session performed by said communication terminals, and
a history information computation function which receives from said communication terminal an interaction history request containing the identifier of the other-party user with which an interaction session is currently being performed and the identifiers of the other communication terminals owned by the owner of own communication terminal; searches, from said history information storage unit, the interaction histories for each interaction session respectively corresponding to the identifiers of the other communication terminals specified in the interaction history request to retrieve interaction histories, each of which contains the other-party user identifier matching the other-party user identifier specified in said interaction history request; determines by referencing said network information storage unit a physical proximity between the logical network which includes said communication terminal currently performing an interaction session with said communication terminal which has sent said interaction history request and the logical network which includes each of the communication terminals identified by the identifiers of the other-party terminals contained in said retrieved interaction histories, and sends to said requesting communication terminal a pair of said retrieved interaction history and said corresponding communication terminal identifier as well as said results of determination.

18. A program running on a computer to serve as a communication terminal connected with a history management device which manages interaction histories between a plurality of communication terminals through a communication network, comprising the history information processing functions of:
when an operation to display interaction histories is performed by the user while an interaction session with another communication terminal is being performed, sending to said history management device an interaction history request which contains the identifier of the other-party user with which an interaction session has been established and the identifiers of the other communication terminals owned by the owner of own communication terminal, and
in response to said interaction history request, receives from said history management device, and displays on the display unit, the interaction histories and the identifiers of the corresponding communication terminals.

19. A program running on a computer to serve as a communication terminal connected with a history management device which manages interaction histories between a plurality of communication terminals, in a mutually communicable way through a communication network, comprising the history information processing functions of:
when an operation to display interaction histories is performed by the user while an interaction session with another communication terminal is being performed, sending to said history management device an interaction history request which contains the identifier of the other-party user with which an interaction session has been established and the identifiers of the other communication terminals owned by the owner of own communication terminal, and
in response to said interaction history request, receives from said history management device an interaction history and said corresponding communication terminal identifier, together with the results of determining a physical proximity between the logical network which includes said communication terminal with which own current terminal has established an interaction session and the logical network which includes the communication terminal identified by the identifier of the other-party terminal contained in said received interaction history, and
displays a list of the identifiers of the other-party communication terminals for each of the received identifiers of own communication terminals contained in each of the corresponding interaction histories, arranged in ascending order of distance to the other-party communication terminal which is currently performing an interaction session, and, when one of the own communication terminal identifiers displayed and one of the corresponding other-party communication terminal identifiers on the list are selected by the user, displays the interaction history between these two selected communication terminals.
